(19) United States
(12) Patent Application Publication
(10) Pub. No.: US 2025/0369889 A1
(43) Pub. Date: Dec. 4, 2025

(54) METHODS AND APPARATUS FOR THE CHARACTERIZATION OF MATTER

(71) Applicant: THE REGENTS OF THE UNIVERSITY OF CALIFORNIA, Oakland, CA (US)

(72) Inventor: Hendrik Utzat, Oakland, CA (US)

(21) Appl. No.: 19/301,164

(22) Filed: Aug. 15, 2025

Related U.S. Application Data
(63) Continuation of application No. PCT/US2024/016466, filed on Feb. 20, 2024.
(60) Provisional application No. 63/485,659, filed on Feb. 17, 2023.
(60) Provisional application No. 63/519,652, filed on Aug. 15, 2023.

(51) Int. Cl. G01N 21/65

(52) U.S. Cl. CPC G01N 21/65; G01N 2201/06113

(57) ABSTRACT

A method and apparatus for the characterization of matter is described. Light from or modulated by the matter is analyzed by means of the spectral correlation. The spectral correlation can report on the composition, static and temporally dynamic characteristics of the matter. The amplitude and temporal characteristics of the spectral correlation are measurement features that report on properties of matter, or changes in local molecular forces, chemical composition, molecular structure, shape, size, charging state, mass, and more. The advantage of spectral correlation of scattered light lies in the increased time-resolution and minimized noise in the spectroscopic characterization of matter, in particular in the characterization of fluctuations. In one embodiment, an apparatus may combine an optical system to illuminate the matter, collect scattered photons, direct these photons into an optical interferometer, and the time-resolved detection of the photons. By performing temporal intensity correlation of the light after the interferometer the spectral correlation is obtained.

### CROSS-REFERENCE TO RELATED APPLICATIONS

This application is a continuation of International Patent Application PCT/US2024/016466, filed Feb. 20, 2004 which claims the benefits of U.S. Provisional Application No. 63/485,659 titled “SPECTRAL FLUCTUATION RAMAN SPECTROSCOPY (SFRS),” filed Feb. 17, 2023, and U.S. Provisional Application No. 63/519,652 titled “INTENSITY-CORRELATION RAMAN SPECTROSCOPY,” filed Aug. 15, 2023, the entire contents of which are incorporated herein by reference.

### BACKGROUND

At finite temperatures all matter exhibits local temporal fluctuations in its atomic spatial coordinates, dictated by the laws of thermodynamics. Additionally and/or alternatively, these fluctuations may also be invoked by other energy sources, such as acoustics or lasers. These fluctuations determine the interaction of matter with other matter and light, and influence all matter's behavior e.g., in the folding, function and dysfunction of proteins or other biomacromolecules as well as their assemblies and complexes, molecular catalysts, and microscopic matter and particles exhibiting quantum behavior, viruses, DNA-protein complexes, enzymes, artificial nanoparticles, or extracellular vesicles.

With reducing number of molecules or particles under observation, the inherent statistical nature of thermodynamic fluctuations becomes in principle experimentally accessible. Conversely, in the limit of an ensemble of molecules or particles, the statistical fluctuations average out and remain elusive to the experiment.

Optical observation and spectroscopy of single or few molecules and particles is therefore a mainstay tool to study temporal fluctuations in different local environments, thus providing (i) information on molecules or particles and its interaction with other particles, and (ii) a way to identify matter via its characteristic fluctuation dynamics. This principle of single-molecule observation is for examples used in fluorescence correlation spectroscopy of particles undergoing Brownian motion, single proteins tagged with fluorescent labels undergoing conformational dynamics, or bio-sensors measuring the binding-and un-binding events between antigens and proteins via statistical analysis of optical signals.

In the context of single-or few-molecule characterization, Raman spectroscopy i.e., the inelastic scattering of photons off a sample, has long been proposed as a powerful tool to obtain spectral fingerprints as a reporter of molecular structure. The Raman spectrum of matter depends on the instantaneous atomic coordinates, from which all other local chemical and bio-chemical properties derive, e.g. ionic strength, pH, inter-and intra-molecular binding strength, or the chemical potential, to name a few.

In turn, the experimental time-resolution of the Raman signal can, in theory, inform on the molecular fluctuations of matter. This would be particularly powerful across the timescales from picoseconds to seconds, which includes the characteristic timescales of thermodynamic fluctuations of many types of matters, including most chemical and biological systems.

However, the intrinsically weak Raman cross-section of matter e.g., compared to molecular electronic absorption, results in low Raman signals and has so far dramatically limited the measurement of Raman spectral information as indicators of matter dynamics.

Raman spectroscopy is thus currently not a reliable tool in the characterization of statistical fluctuations of matter and cannot discern the multi-timescale dynamics of single molecules or particles, which limits its utility to what is below its theoretical power. This shortcoming applies to various fields, including materials science, surface science, analytical chemistry, catalysis, and biomedical diagnostics.

In view of these shortcomings, there is a need to develop a conceptually new method and related apparatus that can resolve Raman spectral information of different types of matter over the exceedingly wide timescales over which the dynamics of complex matter occurs and even in the limit of low signals provided by a single or a few Raman scatterers.

### SUMMARY

Life is fundamentally dynamic, hierarchically emerging from the intricate interplay of biomacromolecules and their movement through time. Structural biophysics has progressed at a staggering pace in recent years due to major advances in experimental techniques providing structural information of biomacromolecules and their complexes down to atomic-scale resolution. Yet, these static snapshots leave the scientific community blind to the dynamics of interactions and conformational changes dictating biological function.

Similarly, all other matter and materials exhibit fluctuations in their atomic configurations that are linked to function of the matter and characteristic of its nature. However, quantification of these fluctuations has been a long-standing challenge owing to the complexity of coupled atomic motion occurring over many orders of magnitude in time.

The present disclosure provides paradigmatically new spectroscopic method and apparatus embodiments for probing conformational dynamics in biological and non-biological matter with transformative sensitivity and access to previously unavailable timescales. The present embodiments apply to all problems involving the study and control of biomolecular dynamics, including protein-protein interactions, drug discovery, and validation of rapidly expanding methods in computational biophysics. More broadly, the techniques enable measuring conformational dynamics of any condensed matter system on previously challenging timescales with applications in catalysis, optoelectronics, semiconductor manufacturing, materials quality control, and beyond.

The present embodiments provide an improved way to characterize the structure and dynamics of different matter using Raman spectroscopy. In particular, embodiments of the present application surpass the temporal resolution, temporal dynamic range, and sensitivity of the state-of-the-art in Raman spectroscopy. Embodiments of the present application achieve an improvement of the obtainable information from Raman spectroscopy of matter. Furthermore, embodiments of the present application enhance sensitivity in the measurement of Raman signals, in particular in the limit of single or few molecules, or particles, viruses, or cells. Additionally, embodiments of the present application may reduce the probability of false signal interpretation from intensity correlations. Moreover, embodiments of the present application enable the extraction of small signals in Raman spectroscopy using new detector technologies and data processing.

In an exemplary embodiment, a spectroscopy system is provided that includes a source of modulated photons, an interferometer, the interferometer having a first optical path and a second optical path, wherein the modulated photons traverse the first optical path and the second optical path, wherein different interferometer positions are obtained by changing a path length of the first optical path during a data acquisition time interval, wherein the interferometer system transcribes temporal spectral fluctuations of the modulated photons to temporal intensity fluctuations, and at least one photo-detector configured to detect the modulated photons output from the first optical path and from the second optical path during the data acquisition time interval. The system also includes a processor coupled with the at least one photo-detector and configured determine a spectral correlation function based on an intensity-correlation analysis of the temporal intensity fluctuations at the different interferometer positions.

In a further exemplary embodiment, the processor is further configured to determine the spectral correlation function by generating a power spectrum based on the detected modulated photons, the power spectrum indicating the temporal spectral fluctuations of the modulated photons detected by the at least one photo-detector, and obtaining, based on correlation of the power spectrum, temporal information of the temporal spectral fluctuations at the different interferometer positions.

In a further exemplary embodiment, the source of modulated photons includes a source of Raman scattered photons.

In an exemplary embodiment, a spectral correlation apparatus is provided that includes a light source configured to excite a sample, optical elements configured to direct light from the light source to the sample and to direct Raman scattered photons from the sample to an interferometer system, the interferometer system including a first optical path and a second optical path, and at least one photo-detector configured to detect the Raman scattered photons output from the first and second optical paths of the interferometer system at two or more different interferometer positions obtained by adjusting an optical path length of one of the first and second optical paths, wherein the interferometer system transcribes temporal spectral fluctuations of the scattered photons to temporal intensity fluctuations. The system also typically includes one or more processors configured to determine a spectral correlation function based on an intensity-correlation analysis of the temporal intensity fluctuations at the different interferometer positions.

In a further exemplary embodiment, the one or more processors are configured to determine the spectral correlation function by generating a power spectrum based on the detected scattered photons, the power spectrum indicating the temporal spectral fluctuations of the scattered photons detected by the at least one photo-detector, and obtaining, based on correlation of the power spectrum, temporal information of the temporal spectral fluctuations at the different interferometer positions.

In another exemplary embodiment, a spectral correlation apparatus is provided that includes a light source configured to generate laser pulses to excite a sample, optical elements configured to direct the laser pulses from the light source to the sample and direct scattered photons from the sample to an interferometer system, where the interferometer system includes a first optical path and a second optical path, and at least one photo-detector configured to detect the scattered photons output from the first and second optical paths of the interferometer system. The apparatus also includes one or more processors configured to determine a synchronization signal based on the laser pulses, determine, based on the synchronization signal and a time-gate associated with the synchronization signal, first photons that are instantaneous scattered photons among the scattered photons detected by the at least one photo-detector, and generate, based on the first photons, a spectrum for the sample.

According to another exemplary embodiment, a Raman spectroscopy system is provided that includes a source of Raman scattered photons, an interferometer, the interferometer having a first optical path and a second optical path, wherein the Raman scattered photons traverse the first optical path and the second optical path, wherein different interferometer positions are obtained by changing a path length of the first optical path during a data acquisition time interval, wherein the interferometer system transcribes temporal spectral fluctuations of the scattered photons to temporal intensity fluctuations, and at least one photo-detector configured to detect the Raman scattered photons output from the first optical path and from the second optical path during the data acquisition time interval. The system also typically includes a processor coupled with the at least one photo-detector and configured to determine a spectral correlation function based on an intensity-correlation analysis of the temporal intensity fluctuations at the different interferometer positions.

In an exemplary embodiment, the processor is further configured to determine the spectral correlation function by generating a power spectrum based on the detected scattered photons, the power spectrum indicating the temporal spectral fluctuations of the scattered photons detected by the at least one photo-detector, and obtaining, based on correlation of the power spectrum, temporal information of the temporal spectral fluctuations at the different interferometer positions.

In a further exemplary embodiment, that the path length of the first optical path is changed during the data acquisition time interval includes changing the path length of the first optical path in a continuous manner.

In a further exemplary embodiment, that the path length of the first optical path is changed during the data acquisition time interval includes changing the path length of the first optical path in a step-wise manner.

In a further exemplary embodiment, that the path length of the first optical path is changed during the data acquisition time interval includes increasing and/or decreasing the path length of the first optical path in a controlled manner.

In a further exemplary embodiment, the processor, or a separate processor, controls an adjustment mechanism coupled to a mirror element in the first optical path to adjust the path length of the first optical path in a controlled manner.

In a further exemplary embodiment, the processor, or a separate processor, controls a dithering mechanism coupled to a mirror element in the first optical path to dither the path length of the first optical path in a controlled manner.

In a further exemplary embodiment, the dithering mechanism includes a Piezo element, an acousto-optic modulator (AOM), an electro-optic modulator (EOM), a mechanical scanner, a liquid crystal devices (LCD), a fiber stretcher, or micro-electromechanical systems (MEMS).

In a further exemplary embodiment, the at least one photo-detector includes a first photo-detector configured to detect photons output from the first optical path, and a second photo-detector configured to detect photons output from the second optical path.

In a further exemplary embodiment, the first photo-detector and the second photo-detector each includes a superconducting nanowire single-photon detector (SNSPD) element, or arrays thereof.

In a further exemplary embodiment, the first photo-detector and the second photo-detector each includes a single-photon avalanche diode (SPAD) array detector element.

In a further exemplary embodiment, the at least one photo-detector includes a first photo-detector pair configured to detect photons output from the first optical path and the second optical path, and a second photo-detector pair configured to detect photons output from the first optical path and the second optical path, wherein the system further includes one or more optical elements configured to direct and/or redirect photons output from the first optical path and the second optical path to the first photo-detector pair and the second photo-detector pair in a controlled manner.

In a further exemplary embodiment, the one or more optical elements include one or more adjustable or switchable mirror elements.

In a further exemplary embodiment, the Raman source includes a radiation source, a sample and optical elements configured to direct radiation from the radiation source to the sample and to direct the Raman scattered photons from the sample to an input of the interferometer.

In a further exemplary embodiment, the radiation source includes a continuous wave laser source or a pulsed laser source.

In a further exemplary embodiment, the radiation source produces or emits coherent radiation having a linewidth of less than about 20 MHz.

In a further exemplary embodiment, the radiation source produces or emits coherent radiation having a linewidth of less than about 20 kHz.

In a further exemplary embodiment, the optical elements includes a notch filter, a prism or other device configured to isolate Stokes and/or anti-Stokes shifted Raman photons.

In an exemplary embodiment, a method is provided to overcome the limitation in time-resolution and temporal dynamic range by means of the frequency-domain correlation of the Raman spectrum to form the spectral correlation. The spectral correlation over time measures the self-similarity of the Raman spectrum, or parts thereof, as a function of the temporal delay. The spectral correlation is therefore a measurement of the self-similarity of atomic configurations leading to changes in the Raman spectrum.

In an exemplary embodiment, a method is provided that includes obtaining scattered photons by performing Raman spectroscopy on a sample, directing the scattered photons into an interferometer having a first optical path and a second optical path, receiving the scattered photons output from the first optical path and the second optical path by at least one photo-detector; generating a power spectrum based on the received scattered photons, and obtaining temporal dynamics of temporal spectral fluctuations based on correlation of the power spectrum. The power spectrum indicates temporal spectral fluctuations recorded by the at least one photo-detector based on the received scattered photons.

In a further exemplary embodiment, the interferometer is a Michelson, Mach-Zehnder, fiber-optic interferometer, Fabry-Perot interferometer, Twyman-Green interferometer, or Fizeau interferometer, or a combination thereof.

In a further exemplary embodiment, the interferometer transcribes the temporal spectral fluctuations to temporal intensity fluctuations. The correlation of the power spectrum is based on intensity-correlation analysis of the temporal intensity fluctuations.

In a further exemplary embodiment, intensity-correlation analysis is performed using a hardware auto-correlator.

In a further exemplary embodiment, the intensity-correlation is performed using algorithmic correlation of an analog intensity signal from the at least one photo-detectors.

In a further exemplary embodiment, the intensity-correlation is performed using algorithmic correlation of photon-arrival time-tagged data.

In a further exemplary embodiment, the detected time-tagged photons from the output of the interferometer are statistically analyzed using artificial neural networks or techniques commonly referred to as machine learning.

In a further exemplary embodiment, receiving the scattered photons output from the first optical path and the second optical path by the at least one photo-detector further comprises receiving the scattered photons by a first photo-detector among the at least one photo-detector output from the first optical path and by a second photo-detector among the at least one photo-detector output from the second optical path.

In a further exemplary embodiment, receiving the scattered photons output from the first optical path and the second optical path by the at least one photo-detector further comprises receiving the scattered photons by a plurality of first photo-detectors among the at least one photo-detector output from the first optical path and by a plurality of second photo-detectors among the at least one photo-detector output from the second optical path.

In a further exemplary embodiment, the method further comprises forming an image of the temporal dynamics of the temporal spectral fluctuations.

In a further exemplary embodiment, receiving the scattered photons output from the first optical path and the second optical path by the at least one photo-detector further comprises adjusting a length of the first optical path to a first distance, detecting the scattered photons output from the first optical path and the second optical path for a predefined time period at the first distance by the at least one photo-detector, adjusting the length of the first optical path to a second distance, and detecting the scattered photons output from the first optical path and the second optical path for the predefined time period at the second distance by the at least one second photo-detector.

In a further exemplary embodiment, the first distance and the second distance are set based on Raman bands of the sample.

In a further exemplary embodiment, the first distance and the second distance are periodically changed by distances of up to a multiple of the wavelengths of the scattered photons.

In a further exemplary embodiment, receiving the scattered photons output from the first optical path and the second optical path by the at least one photo-detector further comprises sweeping a length of the first optical path over a predefined incremental distance, and detecting the scattered photons output from the first optical path and the second optical path for predetermined integration times by the at least one photo-detector.

In a further exemplary embodiment, the method further comprises determining time of arrival for each received scattered photon among the received scattered photons at the respective photo-detector among the at least one photo-detector.

In a further exemplary embodiment, the Raman spectroscopy is surface-enhanced Raman spectroscopy (SERS), Tip Enhanced Raman spectroscopy (TERS), Surface Plasmon Polariton Enhanced Raman spectroscopy (SPERS), Surface Enhanced Resonance Raman spectroscopy (SERRS), Coherent Anti-Stokes Raman Spectroscopy (CARS), Resonant Raman Spectroscopy, Stimulated Raman Spectroscopy, tip-enhanced Raman spectroscopy, or any combination thereof.

In a further embodiment, the Raman spectroscopy uses quantum states of light, including phase and amplitude squeezed states as well as states of entangled photons.

In a further exemplary embodiment, the sample has dielectric or metallic photonic nanostructures, including, but not limited to, nanopillar arrays, cylindrical and elliptical cylindrical dimers, dielectric nanobeams, nanoantennas, plasmonic bowties, plasmonic rods and rod assemblies, plasmonic gap cavities, nanoparticle-on-mirror architectures, nanofluidic channels with photonic responses, dielectric waveguides, assemblies of metallic particles, ordered arrays of dielectric or metallic structured arrays referred to as metasurfaces.

In a further exemplary embodiment, the sample comprises one or more of molecules, proteins, DNA strands, RNA strands, or combinations or complexes thereof.

In a further exemplary embodiment, the sample comprises one or more of exosomes, viral particles, extra-cellular vesicles, or bacteria.

In a further exemplary embodiment, the sample comprises covalently bound or free isotope labels with shifted vibrational frequencies.

In a further exemplary embodiment, the sample comprises covalently bound or free Raman labels.

In a further exemplary embodiment, the sample comprises Raman-active contrast agents in biological cells or other environments.

In a further exemplary embodiment, the sample comprises oligomers or polymers.

In a further exemplary embodiment, the sample comprises a semiconductor material or device.

In a further exemplary embodiment, the sample comprises ceramic material.

In a further exemplary embodiment, the sample comprises artwork, paintings, paper-based materials, fabric, or paint, or pigments.

In a further exemplary embodiment, the sample comprises complex mixtures of biological molecules and particles with the objective of characterizing and separating the mixture's constituents.

In a further exemplary embodiment, the sample may contain pollutants, soil or soil constituents, water, or atmospheric aerosols.

In a further exemplary embodiment, the sample comprises pharmaceuticals or pharmacologically active substances.

In a further exemplary embodiment, the sample comprises organic tissue, tissue slices, or cell cultures.

In a further exemplary embodiment, the method further comprises selecting between a plurality of Raman bands by using one or more optical filters. The one or more optical filters are disposed between the sample and the interferometer.

In a further exemplary embodiment, the at least one photo-detector is a superconducting nanowire single-photon detector, a photo-multiplier tube, an avalanche photo-diode, a detector array, or a combination thereof.

In a further exemplary embodiment, the scattered photons are analyzed based on dynamics of at least one of Stokes and Anti-Stokes Raman peaks of an amino acid.

In a further exemplary embodiment, the scattered photons are analyzed for multiple Raman peaks comprising the at least one of Stokes and Anti-Stokes Raman peaks of the amino acid.

In a further exemplary embodiment, the method comprises correlating two vibrational modes corresponding to different sites of the sample, and obtaining a correlated motion between different domains within the sample.

In a further exemplary embodiment, the power spectrum indicates energy difference of photon-pairs as a function of time difference thereof. Each photon-pair comprises a photon among the scattered photons received by the at least one photo-detector from the first optical path and a photon among the scattered photons received by the at least one photo-detector from the second optical path.

In a further exemplary embodiment, the scattered photons are excited by a light source with a tunable wavelength. A detection wavelength corresponding to the at least one photo-detector for the scattered photons is set to be constant.

In another exemplary embodiment, a method is provided. The method is provided that includes obtaining, by performing Raman spectroscopy on a sample using laser pulses, scattered photons; determining a synchronization signal based on the laser pulses; determining, based on the synchronization signal and a time-gate associated with the synchronization signal, first photons that are instantaneous Raman-scattered photons; and generating, based on the first photons, a Raman spectrum for the sample.

In a further exemplary embodiment, the laser pulses are generated by a pulsed laser source or a time-modulated laser source.

In a further exemplary embodiment, the time gate associated with the synchronization signal is a specific time period after the particular synchronization signal.

In a further exemplary embodiment, determining, based on the synchronization signal and the time-gate associated with the synchronization signal, the first photons that are instantaneous Raman-scattered photons comprises: performing time-domain correlation between the scattered photons and the synchronization signal to extract intensity fluctuations of the sample in time-domain; determining, based on the intensity fluctuations of the sample in time-domain, time differences between the scattered photons and the synchronization signal; and determining, based on the time differences associated with particular scattered photons within the time gate, that the particular scattered photons are the first photons.

In a further exemplary embodiment, the method further comprises: determining, based on the time differences associated with particular scattered photons beyond the time gate, that the particular scattered photons are second photons that are background photons; and filtering out the second photons.

In a further exemplary embodiment, the scattered photons are detected by one or more single-photon sensitive detectors.

In a further exemplary embodiment, the one or more single-photon sensitive detectors comprise superconducting nanowire single-photon detectors (SNSPDs) and/or other single-photon sensitive detectors.

In a further exemplary embodiment, the one or more single-photon sensitive detectors comprise point-like, line-like, or array-like detectors.

In a further exemplary embodiment, the sample is of any type disclosed in the present disclosure.

In a further exemplary embodiment, the sample is a liquid sample comprising analytes, where intensity fluctuations of the analytes encode diffusion dynamics in a Raman-equivalent of fluorescence-correlation spectroscopy.

In yet other embodiments, a system, apparatus, and non-transitory computer-readable media are provided to facilitate methods disclosed herein.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

The present method, system, and apparatus for characterization of matters are described in detail below with reference to the attached drawing figures, wherein:

FIG. 1 is a diagram illustrating exemplary conformational dynamics on the timescale.

FIG. 2A is a diagram of exemplary energy diagrams indicating one origin of Raman spectral fluctuation, in accordance with some embodiments.

FIG. 2B shows exemplary equilibrium changes of the conformation in single proteins.

FIG. 2C demonstrates exemplary changes in the equilibrium nuclear coordinates of a vibrational mode of a tether molecule

FIG. 2D illustrates exemplary spectral fluctuations, in accordance with some embodiments.

FIGS. 3A and 3B are schematics demonstrating an exemplary implementation of SFRS, in accordance with some embodiments.

FIG. 3C is a schematic diagram of another exemplary implementation of Spectral Fluctuation Raman Spectroscopy (SFRS), in accordance with some embodiments.

FIG. 3D is a schematic diagram illustrating super-resolution image equivalents of the position of independently spectrally fluctuating Raman scatterers in an image plane, in accordance with some embodiments.

FIG. 3E is a schematic diagram of another exemplary implementation of Spectral Fluctuation Raman Spectroscopy (SFRS), in accordance with some embodiments.

FIG. 4 shows a preliminary phenomenological simulation, in accordance with some embodiments.

FIGS. 5A and 5B illustrate an exemplary SFRS analysis, in accordance with some embodiments.

FIG. 6A shows an exemplary FUS protein, in accordance with some embodiments.

FIG. 6B shows an exemplary Tyr-based low-complexity aromatic-rich kinked segments (LARKS) network, in accordance with some embodiments.

FIG. 6C is a diagram illustrating exemplary conformational dynamics observable by SFRS, in accordance with some embodiments.

FIG. 7 is an exemplary process of matter characterization, in accordance with some embodiments of the present disclosure.

FIG. 8 illustrates a block diagram of an exemplary computer system configured to implement various functions according to one or more embodiments in the present disclosure.

FIG. 9 is an exemplary process of matter characterization in accordance with one or more embodiments of the present disclosure.

FIG. 10 shows an exemplary Raman assay, in accordance with some embodiments.

FIG. 11 shows exemplary spectral fluctuations, in accordance with some embodiments.

FIG. 12A shows exemplary spectral fluctuations with applied force, in accordance with some embodiments.

FIG. 12B shows exemplary SFRS simulations, in accordance with some embodiments.

### DETAILED DESCRIPTION

The present disclosure presents paradigmatically new spectroscopic methods and apparatus for performing Raman spectroscopy with, in principle, arbitrarily high time-and spectral-resolution despite the notoriously low signal strength, all while being minimally perturbative and “label-free.”

In the context of single-or few-molecule characterization, Raman spectroscopy i.e., the inelastic scattering of photons off a sample, has long been proposed as a powerful tool to obtain spectral fingerprints as a reporter of molecular structure. The Raman spectrum of matter depends on the instantaneous atomic coordinates, from which all other local chemical and bio-chemical properties derive, e.g. ionic strength, pH, inter-and intra-molecular binding strength, or the chemical potential, to name a few. In turn, the experimental time-resolution of the Raman signal can, in theory, inform on the molecular fluctuations of matter. This would be particularly powerful across the timescales from picoseconds to seconds, which includes the characteristic timescales of thermodynamic fluctuations of many types of matters, including most chemical and biological systems.

However, the intrinsically weak Raman cross-section of matter e.g., compared to molecular electronic absorption, results in low Raman signals and has so far dramatically limited the measurement of Raman spectral information as indicators of matter dynamics. This limitation is particularly present in the observation of few or single molecules exhibiting discernable equilibrium fluctuations, as few particles produce a proportionally even lower Raman signal. The low signal strength thus precludes the analysis of Raman spectral dynamics across the timescales from picoseconds to seconds which include the timescales most critical in chemical and biological systems and commensurate with molecule motion, rotation, conformational exchange, diffusion, and binding-and-unbinding events (as discussed in Langer et al. (2019), “Present and Future of Surface-Enhanced Raman Scattering,” ACS Nano 2020, 14, 1, 28-117; Hu, X. & Spiro, T. G. (1997), “Tyrosine and Tryptophan Structure Markers in Hemoglobin Ultraviolet Resonance Raman Spectra: Mode Assignments via Subunit-Specific Isotope Labeling of Recombinant Protein,” Biochemistry 36, 15701-15712).

Enhancement of the Raman signal with photonic cavities or optical antennas made from dielectric or plasmonic resonators, referred to as cavity-and surface-enhanced Raman spectroscopy (SERS), has improved the accessible time-resolution in few-and single-molecule Raman spectroscopy. Although time-resolution of spectral dynamics can in rare cases reach microseconds, most studies are limited to temporal resolutions of milliseconds. Moreover, a trade-off exists between the signal-strength and the spectral quality of the Raman signal and the generality of Raman spectral analysis for the study of molecules and particles. As such, the highest Raman signal enhancements (and thus time resolutions) are achieved with narrow (<5 nm) plasmonic gap cavities, which excludes the study of larger analytes like most macromolecules, viruses, cells, and nanoparticles.

Raman spectroscopy is thus currently not a reliable tool in the characterization of statistical fluctuations of matter and cannot discern the multi-timescale dynamics of single molecules or particles, which limits its utility to what is below its theoretical power. This shortcoming applies to various fields, including materials science, surface science, analytical chemistry, catalysis, and biomedical diagnostics.

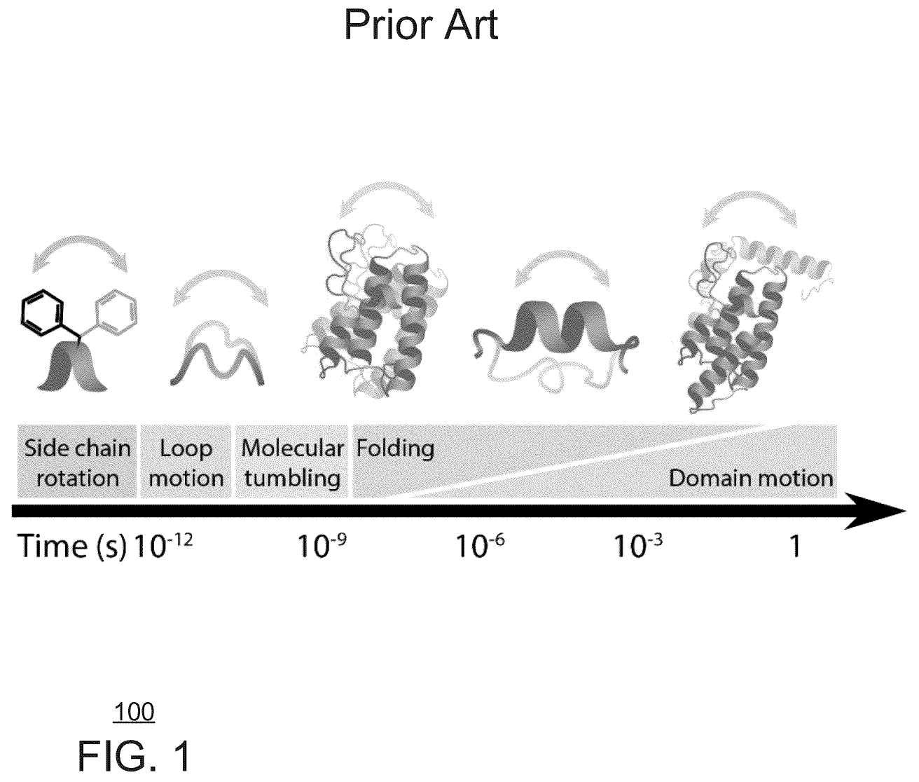

One area that would particularly benefit from a measurement of atomic fluctuations is the field of protein science. Protein conformational dynamics affect DNA transcription, regulate energy-transfer in photosynthesis and enzyme activity, and drive the transition from healthy to diseased states. Yet, all protein functions (and dysfunctions) can in principle be described by a dataset containing the full-timescale propagation of all nuclear coordinates, equivalent to a “molecular movie.” Subjected to thermodynamic fluctuations at physiological conditions, biomolecules traverse high-dimensional energy landscapes. Nuclear motion is driven on timescales from femtoseconds to seconds involving bond vibrations, side-chain rotations, loop formation, and global conformational changes. FIG. 1 is a diagram 100 illustrating exemplary conformational dynamics on the timescale. As depicted in FIG. 1, protein conformational dynamics occurs on timescales ranging from picoseconds to tens of seconds, thus requiring a technique with high temporal dynamic range for its assessment (as described in Henzler-Wildman, K., Kern, D. (2007), “Dynamic personalities of proteins,” Nature 450, 964-972).

Unfortunately, there simply is no experimental technique providing the full information content of data resembling “molecular movies” of protein motion, hampering the rationalization of higher-order protein function. Ensemble techniques such as Nuclear Magnetic Resonance can access protein dynamics, but average over different protein isoforms, conformational states, and bound and unbound protein-complexes (as discussed in Schneider, R., Blackledge, M., Ringkjøbing Jensen, M. (2019), “Elucidating binding mechanisms and dynamics of intrinsically disordered protein complexes using NMR spectroscopy,” Current Opinion in Structural Biology, 54, 10-18). Single-protein studies can overcome these inherent problems of ensemble-averaging and commonly infer conformational dynamics from the optical signatures of organic dyes or noble-metal nanoparticles tethered to the protein (as discussed in Roy, R., Hohng, S. & Ha, T. (2008), “A practical guide to single-molecule FRET,” Nat. Methods 5, 507-516), approaches that can provide some access to fast dynamics, but that are perturbative and limited in the number of protein sites and degrees of freedom that can be co-observed. Single-protein Raman spectroscopy overcomes these limitations by being “label-free” and inherently sensitive to different chemical moieties and protein sites imprinting in different regions of the Raman spectrum (as discussed in Habuchi, S. (2003), “Single-Molecule Surface Enhanced Resonance Raman Spectroscopy of the Enhanced Green Fluorescent Protein,” J. Am. Chem. Soc. 125, 28, 8446-8447). However, Raman spectroscopy exhibits orders of magnitude weaker signal compared to the emission of dyes as mentioned above, preventing access to fast timescales in conventional measurement schemes, typically involving spectral dispersion with a grating spectrometer and frame-by-frame spectral measurements with a camera.

As a protein is statistically sampling its configuration space, different configurations exhibit slightly different frequencies of the Raman scattered photons. Correlation functions may be implemented to analyze such statistical fluctuations around an equilibrium of both the conformational coordinate and spectral frequency. Correlation functions measure by how much, on average, a given quantity will have changed from one point in time to another. For example, in the context of protein shape fluctuations, the correlation function of the distance between two protein arms encodes typical fluctuation time-constants and amplitudes. Similarly, in the context of optical spectroscopy, the spectral correlation function measures by how much, on average, an optical spectrum has shifted in frequency over a given time period. This kind of spectral correlation analysis of the Raman scattered photons may be used to measure statistical conformational fluctuations, when the conformational and spectral fluctuations are coupled.

In some examples, a method and apparatus for the characterization of matter, e.g. proteins, viruses, molecules, nanoparticles, tissue, and materials, etc. are described. Light modulation (e.g., caused by reflection, refraction, diffraction, absorption, scattering, and/or other suitable processes) from the matter is analyzed by means of the spectral correlation, e.g., the frequency domain correlation of the scattered light's power spectrum or some frequency bands of the power spectrum. The spectral correlation can report on the composition, static and temporally dynamic characteristics of the matter. The amplitude and temporal characteristics of the spectral correlation are measurement features that report on properties of matter, e.g., the conformational dynamics of molecules, changes in pH, temperature, pressure, or changes in local molecular forces, chemical composition, molecular structure, shape, size, charging state, and mass. The advantage of spectral autocorrelation of scattered light lies in the increased time-resolution and minimized noise in the spectroscopic characterization of matter. In one embodiment, an apparatus may combine an optical system to illuminate the matter, collect scattered photons, direct these photons into an optical interferometer, and the time-resolved detection of the photons. By performing temporal intensity correlation of the light after the interferometer the spectral correlation is obtained.

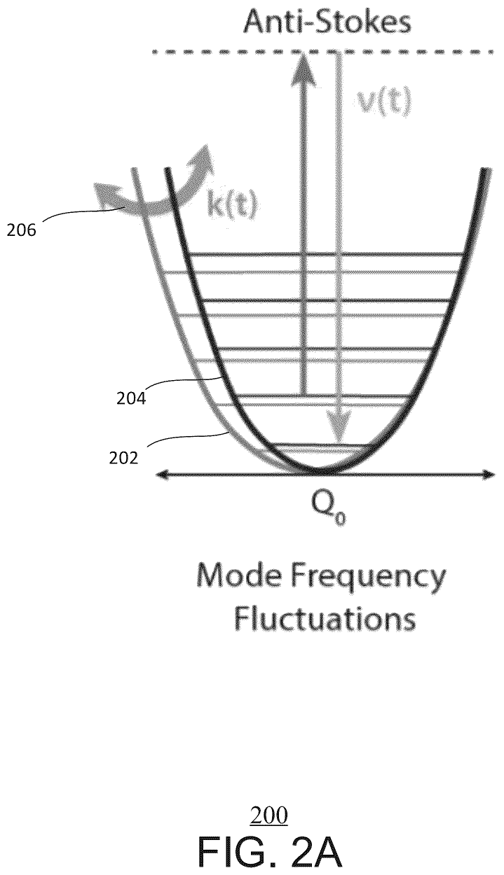

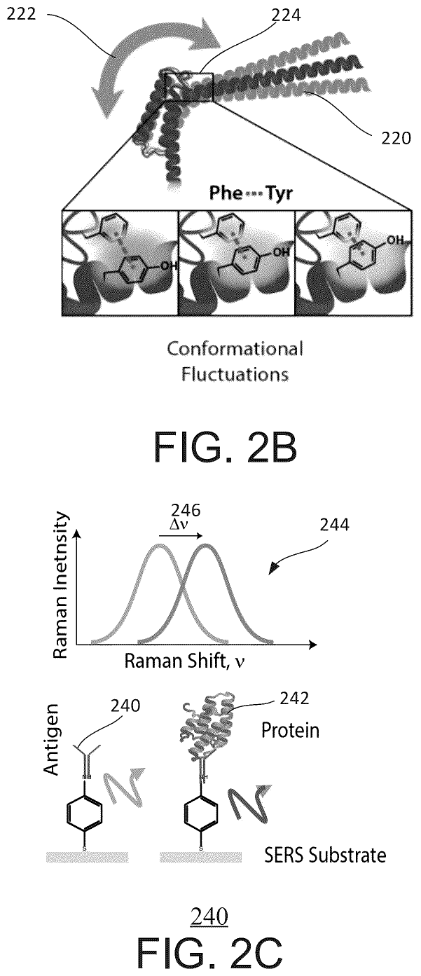

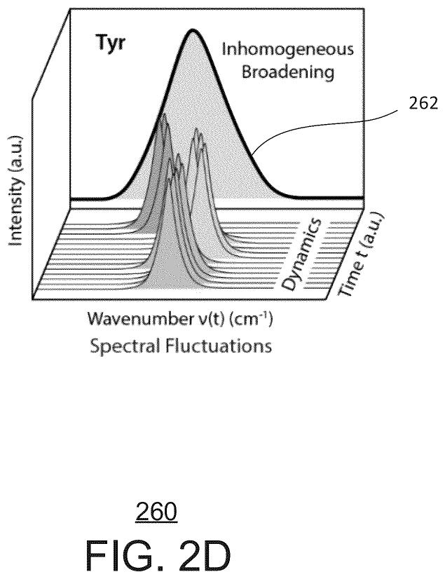

FIG. 2A is a diagram of exemplary energy diagrams, in accordance with some embodiments. As depicted in FIG. 2A, the diagram 200 demonstrates the concept of force-induced changes to the Raman spectrum. For example, at time (t), a force 206 applied to a molecular entity may cause its energy diagram to change from 202 to 204, resulting in changes in absorbed/emitted/scattered photons (e.g., with wavenumber of v(t)). k(t) may represent the time-dependent stiffness of molecular “tethers” due to changes in intra-and intermolecular forces. In an example, when molecular bonds experience a stretching force 206, the equilibrium bond-length and vibrational frequency changes. Changes in the equilibrium nuclear conformation of any molecular entity alters the frequency of vibrational modes.

It will be understood by one skilled in the art that various other factors may contribute to fluctuations in Raman spectra, such as temperature, hydrogen-bonding, pi-pi-stacking, hydration, local ion concentration, electric fields, photon-phonon interactions, lattice defects/disorder, chemical environment, and more.

FIG. 2B shows exemplary equilibrium changes of the conformation in single proteins. As shown in FIG. 2B, Raman spectra fluctuations may arise from both intra-and intermolecular forces (e.g., indicated by arrow 222) (e.g., pico-Newtons) acting on molecular “tethers” in protein 220. Box 224 shows various equilibrium bond-lengths between Phenylalanine (Phe) and Tyrosine (Tyr).

FIG. 2C demonstrates exemplary changes in the equilibrium nuclear coordinates of a vibrational mode of a tether molecule. As shown in FIG. 2C, the binding of antigens 240 to antibodies 242 has resulted in vibrational frequency shift (e.g., 246 in diagram 244) due to mechanical stress instigated by antigens in the antibody-linked SERS system, which were a substantial fraction of the ensemble Raman linewidth. In turn, fluctuations in mechanical stress e.g. caused by conformational changes of the protein or binding-unbinding events with the antibody will cause spectral fluctuations in the vibrational mode of the tether molecule. Such a spectral fluctuation assay may further be used to measure enzyme kinetics, the mass, shape, and size of analytes, and substrate binding of biomolecules and/or small molecules.

FIG. 2D illustrates exemplary spectral fluctuations. As shown in the diagram 260, spectral fluctuations of the Raman signal of molecules may lead to shifts in the Raman signal's wavenumber (v(t)) over time. Owing to the low signal strength, previous Raman spectroscopy required integration times that obfuscated any fast spectral dynamics by time-averaging (e.g., curve 262). This problem of poor time resolution is particularly prominent in the limit of low Raman signals e.g. in surface-enhanced Raman spectroscopy and in the limit of few or single molecules or particles. The problem is further inherent to grating-based Raman spectroscopy, constituting the majority of applications. In grating-based spectroscopy, the spectrum is dispersed with an optical grating using diffraction prior to detection, generating a power-spectrum. To measure fast spectral dynamics, the integration must be decreased to increase the framerate of spectral snapshots, this increasingly reducing the signal-to-noise ratio. The inherently weak Raman signals together with the lowering throughput with increasing resolution of grating-spectrometers—required to pick up small spectral shifts—this conventional approach is fundamentally limited in its ability to resolve fast spectral fluctuations. This is particularly true in scenarios of few or single Raman scatterers with low signal.

The problem of poor time resolution can be solved by the proposed technique, Spectral Fluctuation Raman Spectroscopy (SFRS). SFRS implements spectral correlation functions. Correlation functions can, in theory, be computed with arbitrary time-resolution and dynamic range, only subject to statistical noise which can be reduced by prolonging the experimental observation time. Specifically, SFRS measures the spectral correlation function i.e, the frequency-domain correlation of the power spectrum compiled from pairs of photons with different detection time-delays. This spectral correlation function is a measure of the time-average energy-difference between two Raman scattered photons as a function of their temporal separation. In the case of Raman spectral fluctuations from conformational changes, the energy-difference between photons encodes corresponding changes of conformational coordinate of the scattering moiety. In other words, just as the spectral correlation encodes by how much, on average, the Raman spectrum will have changed over a given time period, the spectral correlation also encodes by how much, on average, the conformation of sample molecules will have changed of that time period. Because the time-difference between two scattered photons has no intrinsic limit and, statistically, with sufficiently long measurement time, enough photon-pairs with short i.e. nanosecond to millisecond separation can be collected. This decoupling of accessible temporal timescales of the spectral correlation function and the measurement time endows SFRS with, in theory, unlimited temporal resolution, practically only limited by the response function of the employed photo-detectors. The use of optical interferometry further bestows SFRS with in theory unlimited spectral resolution without compromising accessible timescales or signal strength, allowing SFRS to pick up even the most miniscule spectral changes, previously inaccessible.

Photons will constructively interfere at different interferometer output arms with different probabilities depending on the spectral distribution of the photon and the path-length-difference of the interferometer. For a time-invariant spectral distribution of all photons, a known interferometer path-length difference and known temporal adjustments of it will translate into well-defined intensity-correlations. Consequently, if the spectral distribution of photons changes stochastically e.g., owing to spectral fluctuations of the Raman scatterer, the intensity correlation at the output of the interferometer will change accordingly. Taken together, an interferometer can transcribes temporal spectral fluctuations into temporal fluctuations in the intensity i.e., photon counts per time interval and the intensity correlations may be used to quantify the spectral fluctuations of the sample Raman photons.

This interferometric photon-correlation approach is the key to the enhanced time-resolution of SFRS, as it decouples the temporal resolution from the experiment's integration time. In some examples, the temporal resolution may be increased by increasing the experiment's integration time. Increasing the interferometer path-length difference further advantageously bestows SFRS with in principle unlimited spectral resolution without compromising accessible timescales or signal strength, allowing SFRS to pick up even the most miniscule spectral changes.

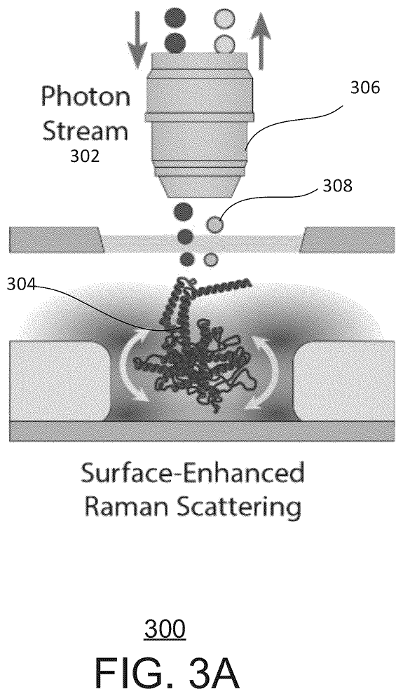

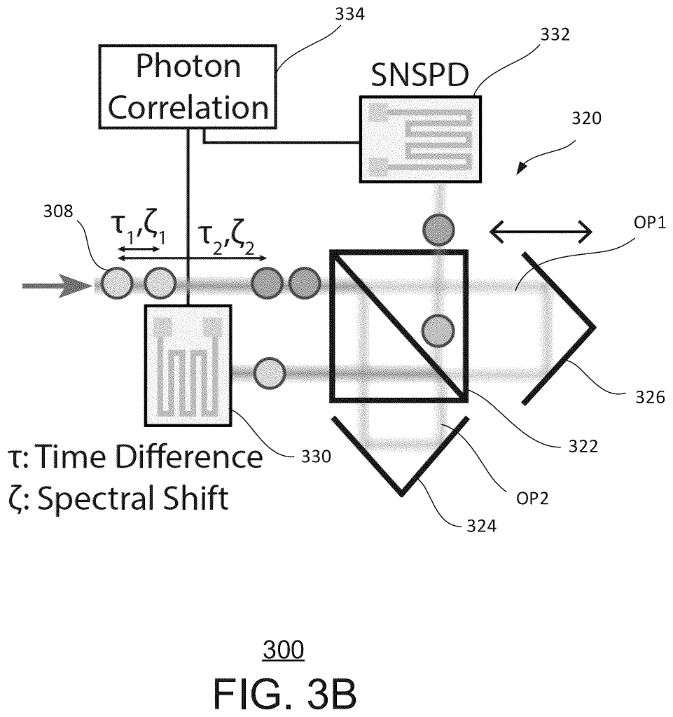

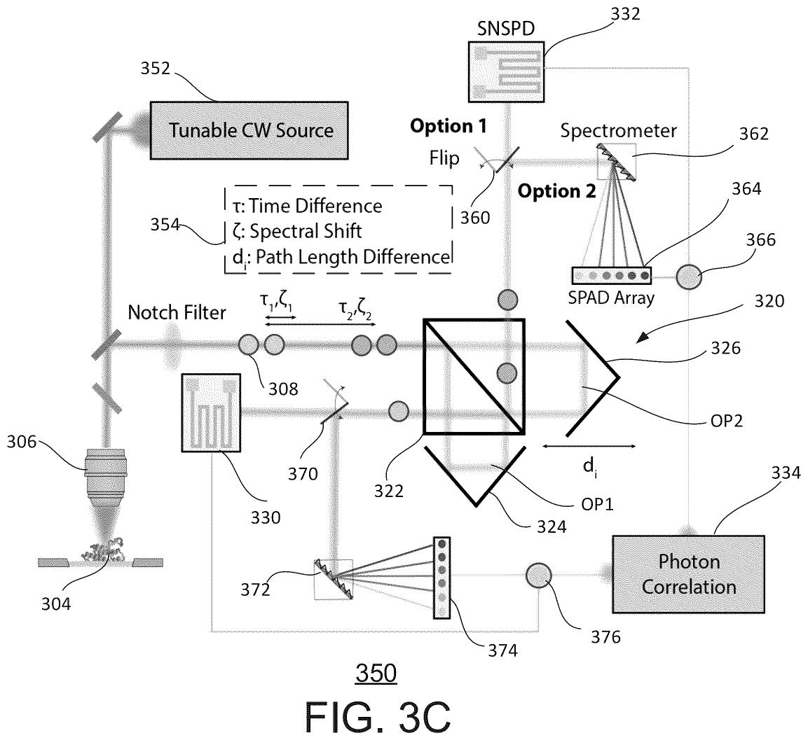

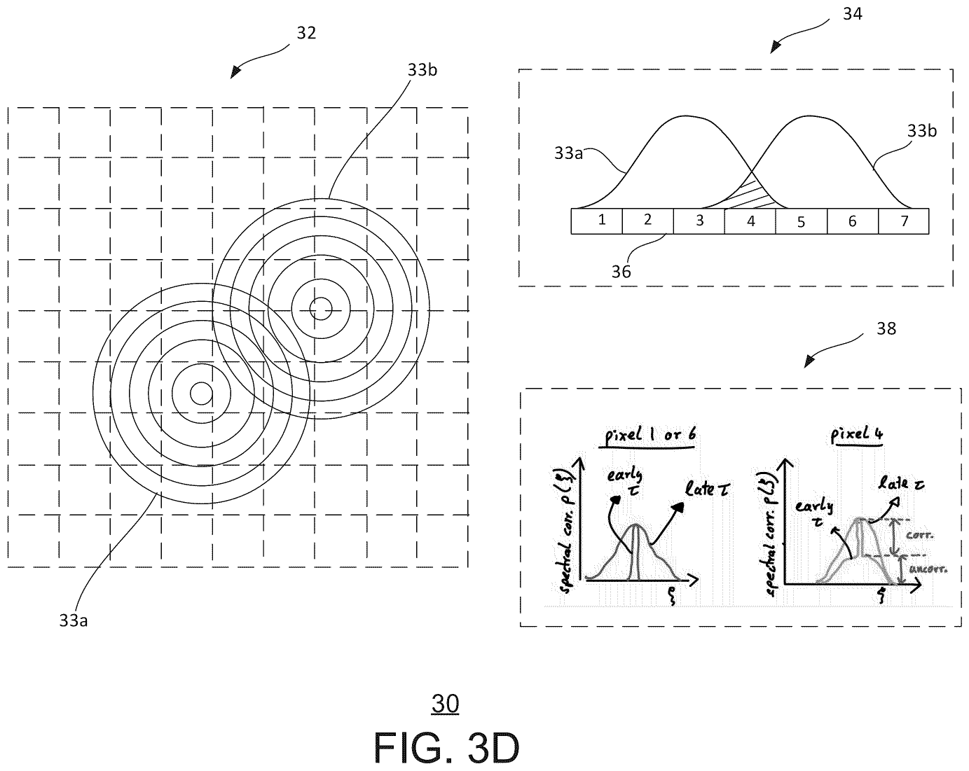

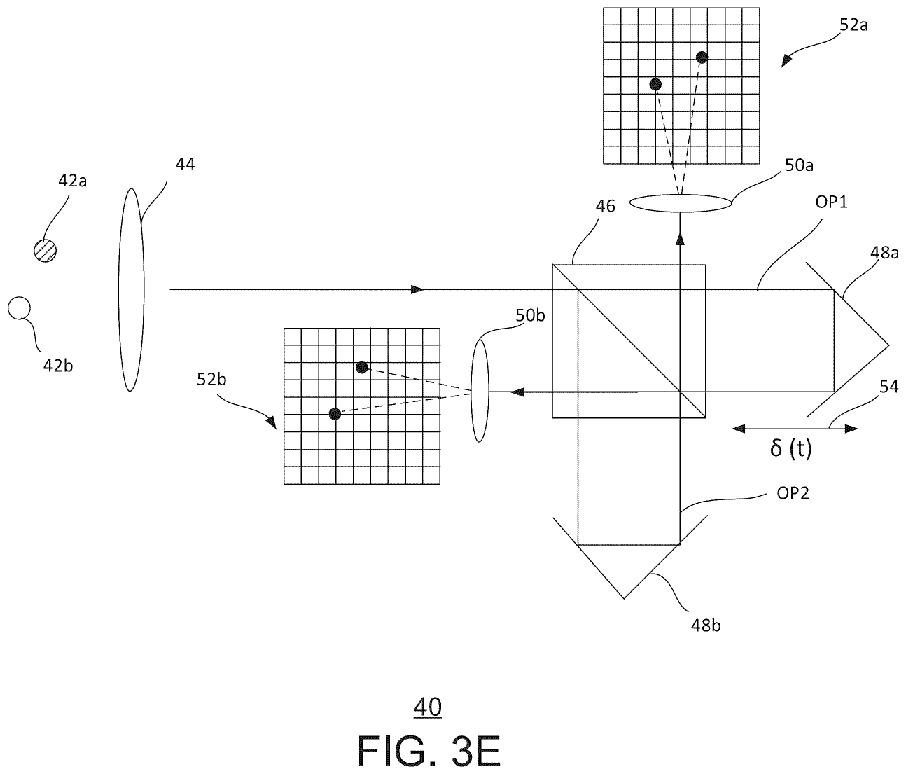

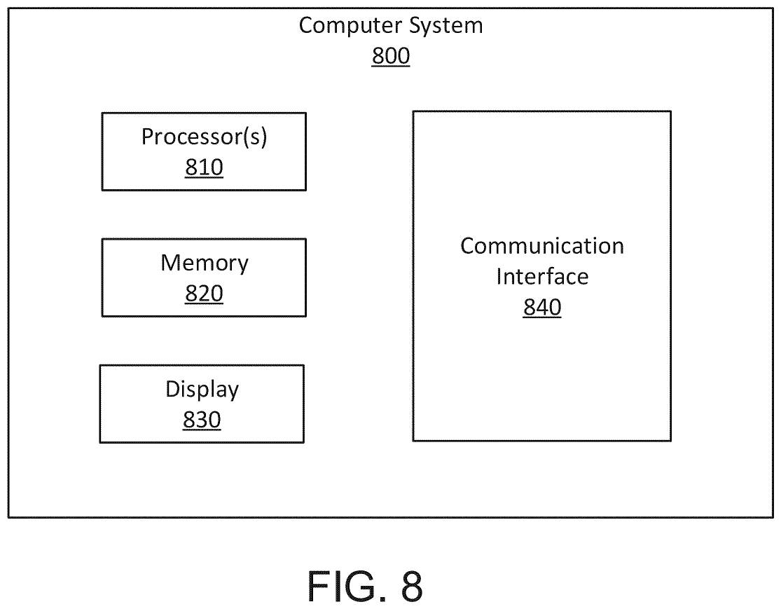

FIGS. 3A and 3B are schematics demonstrating an exemplary implementation of a SFRS system 300 (“SFRS 300”), in accordance with some embodiments. As shown in FIG. 3A, a photon stream 302 is directed to a sample 304 via an objective lens 306 of a confocal microscope. Consequently, a stream of excited photons 308 is collected by the objective lens 306 of the confocal microscope. Referring to FIG. 3B, the SFRS 300 parses the stream of excited photons (e.g., using optical component(s) 322, 324, and 326), guiding the photons to travel through different paths in an optical interferometer system (e.g., the system 320) and measuring spectral fluctuations using superconducting-nanowire single-photon detectors (SNSPDs) (e.g., detectors 330 and 332). A computing system 334 (e.g., a computer system 800 as depicted in FIG. 8) may be utilized to perform photon correlation.

According to an embodiment, as shown in FIG. 3B, scattered photons 308 obtained by performing Raman spectroscopy on a sample as shown in FIG. 3A are directed to an interferometer (e.g., interferometer system 320). The interferometer includes a first optical path OP1 and a second optical path OP2, which paths are defined by the various optical components of the interferometer system. For example, as shown in FIG. 3B, optical components in an embodiment may include a beamsplitter element 322 and two mirror elements (e.g. retroreflectors) 324, 326, one for each of path OP1 and path OP2. It will be understood by one skilled in the art that additional and/or alternative optical components may be used to implement the interferometer system 320 and guide the photons and provide controlled path length differences as described. The scattered photons output from the first optical path OP1 and the second optical path OP2 are received or detected by detector 330 and detector 332, respectively. It will also be understood that a single detector may be used, wherein each of paths OP1 and OP2 are directed to the single detector with a time-delay, or where just one path is directed to the single-detector. Alternatively, a plurality of detectors may be used to detect scattered photons from any of the optical paths. It will also be understood that the output of the interferometer may be coupled into an optical fiber leading to a detector for photo-detection.

In some examples, the interferometer is a Michelson, Mach-Zehnder, fiber-optic interferometer, Fabry-Perot interferometer, Twyman-Green interferometer, or Fizeau interferometer, or a combination thereof. The interferometer transcribes the temporal spectral fluctuations to temporal intensity fluctuations. The correlation of the power spectrum is based on intensity-correlation analysis of the temporal intensity fluctuations at different interferometer positions.

Detectors 330 and 332 are coupled with computing system 334 and provide detection signals representative of the signals detected by each of detectors 330 and 332 to computing system 334. In an embodiment, a frequency domain correlation function of the spectrum of photons may be determined, such as a spectral correlation function based on an intensity-correlation analysis of the temporal intensity fluctuations at the different interferometer positions. In a further embodiment, computing system 334 generates a power spectrum based on the received scattered photons (e.g., based on signals received from detectors 330, 332), where the power spectrum may indicate temporal spectral fluctuations detected or recorded by the detectors 330, 332. Computing system 334 may also, in some embodiments, determine temporal dynamics of the temporal spectral fluctuations based on correlation of the power spectrum. For example, the computing system 334 may form an image of the temporal dynamics of the temporal spectral fluctuations, e.g., for display on a display device coupled with the computing system 334, or other computing system.

In some instances, intensity-correlation analysis is performed using a hardware auto-correlator (e.g., integrated in or coupled to the computing system 334). In some variations, the intensity-correlation is performed, by the computing system 334, using algorithmic correlation of an analog intensity signal from the at least one photo-detectors 330 and 332. Additionally, and/or alternatively, the intensity-correlation may be performed using algorithmic correlation of photon-arrival time-tagged data. In further examples, the detected time-tagged photons from the output of the interferometer may be statistically analyzed using artificial neural networks or techniques commonly referred to as machine learning.

According to an embodiment, to implement the interferometric processing of the photons 308, a length of the first optical path OP1 is adjusted to a first distance (and a path length of OPD2 is maintained), and the scattered photons output from the first optical path OP1 and the second optical path OP2 are detected for a first data acquisition time period. Thereafter, the length of the first optical path OP1 is adjusted to a second distance (and a path length of OP2 is maintained), and the scattered photons output from the first optical path OP1 and the second optical path OP2 are detected for a second data acquisition time period, which may be different than or the same as the first data acquisition time period. Alternatively, the length of the first optical path OP1 may be maintained and the length of the second optical path OP2 may be adjusted in the above method. In some embodiments, the first distance and the second distance are set based on Raman bands of the sample. In some embodiments, the first distance and the second distance are periodically changed, e.g., by distances of up to a multiple of the wavelengths of the scattered photons. In further embodiments, the pathlength of OP1 and/or OP2 of the interferometer may be changed during the data acquisition, (e.g., photo-detection). For instance, the SFRS may be performed by adjusting OP1 (and/or OP2) to discrete path differences and then slowly dithering around that central distance while collecting photons. In some embodiments, the pathlength of OP1 and/or OP2 of the interferometer may be adjusted in a step-wise/incremental manner, continuously swept, adjusted incrementally and dithered, etc. In some examples, the dithering mechanism includes a Piezo element, an acousto-optic modulator (AOM), an electro-optic modulator (EOM), a mechanical scanner, a liquid crystal devices (LCD), a fiber stretchers, or micro-electromechanical systems (MEMS).

According to an embodiment, to implement the interferometric processing of the photons 308, a pathlength of the first optical path OP1 is swept by an incremental distance (which may be defined or arbitrary). The scattered photons output from the first optical path OP1 and the second optical path OP2 are received or detected by one or more photo-detectors (e.g., detector 330 and detector 332).

According to an embodiment, computing system 334 determines the time of arrival for each received scattered photon among the received scattered photons at the respective photo-detector among the one or more photo-detectors.

According to an embodiment, one or more optical filters are disposed between the sample and the interferometer or between the sample and the detector. The one or more optical filters may be utilized to select between a plurality of Raman bands and to reduce detection of unwanted photon e.g. background or excitation source light.

FIG. 3C is a schematic diagram of another exemplary implementation of SFRS, in accordance with some embodiments. As shown in FIG. 3C, certain components (e.g., the objective 306, the optical components 322, 324, and 326, the photo-detectors 330 and 332, and more) from the implementation 300 as depicted in FIGS. 3A and 3B may be reused in the implementation 350. In this example, the light source 352 may be a tunable continuous wave (CW) light source, such as a Ti:Sapphire pumped tunable ring laser (400-1000 nm wavelength), is used as a SFRS excitation laser. The laser 352 produces ultra-narrow linewidth (<20 kHz) with minimal spectral jitter (<20 Mhz). This intrinsic spectral jitter is orders of magnitude smaller than typical homogeneous Raman linewidths (tens to hundreds of GHz) and Raman spectral fluctuations. A Faraday isolator may be placed in the output beam path to block the detrimental back reflection into the cavity. The objective 306 may include a high numerical aperture microscope objectives (NA 1.2, oil immersion at ambient conditions) that collects Raman scattered photons (e.g., scattered photons 308). The scattered photons 308 may pass through a tunable notch filter to isolate Stokes and anti-Stokes shifted Raman photons. Stokes-shifted Raman photons are parsed into a variable-path interferometer 320, such as a Michelson interferometer, that undergoes a periodic dither motion on second timescale and over several micrometers. This dither has been shown mathematically to transcribe spectral fluctuations into intensity fluctuations that are recorded by time-stamped single-photon detection at the output arms of the interferometer. As shown in dashed box 354, τ represents time difference between photons, ζ represents spectral shift, and dᵢ represents path length difference between OP1 and OP2.

These intensity fluctuations are characterized with path-length difference-dependent intensity correlations (g⁽²⁾(δᵢ,τ)), where δ corresponds to the i-th center path length differences dᵢ. For this, the interferometer performs a path-length difference change (continuous or periodic) around several center path-length differences (dᵢ), where the index i indicates a given center pathlength difference. The path-length difference change occurs over small distances on the order of the wavelength of light and for the duration of the acquisition time of intensity data needed for the (g⁽²⁾(δᵢ,τ)). The velocity of this path-length difference modulation v=delta d/delta t, where t is the time, is chosen so that the path-length difference is changed by substantially less than one wave period of the light over the characteristic time-period of the spectral fluctuations to be measured. In one embodiment, this may be accomplished by dithering the interferometer over one or a few wave periods of light over the course of several seconds. This dithering motion (or slow continuous change) around the center path-length difference is useful in SFRS; it serves to induce temporal anti-correlations into the g⁽²⁾(δᵢ,τ) correlation function recorded between the two optical outputs of the interferometer. The magnitude of this anti-correlation in g⁽²⁾(δᵢ,τ) can be extracted by comparison with the intensity of the auto-correlation of the sum signal of the two interferometer outputs, which accounts for any intensity changes from the sample itself, and not from spectral fluctuations. The magnitude of this anti-correlation at a given path-length difference i is related to the degree of optical coherence of the light at i-th that path-length difference. Consequently, the envelop of the optical coherence at different path-length differences can be compiled for different dᵢ. Rigorously, the mathematical quantity obtainable is the square of the optical interferogram's envelop compiled from photon-pairs with a temporal separation of τ. Consequently, invoking the convolution theorem, Fourier transform from δ to frequency ω of the squared envelop gives the main SFRS observable, the time-dependent spectral correlation function (p(ζ,τ)), where ζ is the energy difference and τ the time difference between two photons. The power of SFRS lies in the fact that p(ζ,τ) can be obtained with very high time and spectral resolution, which is possible by sacrificing the phase information of the scattered photons to gain temporal resolution. In applications such as sensing of molecular Raman spectral fluctuations, the absolute phase information of the interferogram contains trivial information (the absolute energy of the Raman peak). It is the change of the Raman lines in energy that is useful to make assertions about corresponding conformational changes.

The implementation 350 implements two complementary approaches for photon-detection. Suitable optical components (e.g., the switchable or flappable mirrors 360 and 370) may be utilized for switching between the photon-detection approaches as depicted in FIG. 3C. For example, in a first position for the mirrors 360 and 370, superconducting nanowire single-photon detectors (SNSPDs) 330, 332 may be used for photon-detection with maximal signal-to-noise. In a second position for the mirrors 360 and 370, single-photon avalanche diode (SPAD) array detectors 364, 374 with corresponding spectrometers 362, 372, may be used for photon-detection, to maximize the spectroscopic information content by measuring the spectral correlation function of multiple Raman spectral lines simultaneously, and in spectral cross-correlation with each other to establish how different Raman spectral lines are correlated in their temporal fluctuations. Elements 366 and 367 represent communication nodes (e.g., switching circuit) enabling receipt of signals from detectors 364, 374 and detectors 330, 332 in controllable, alternating or simultaneous fashion. The elements 366 and 367 may be integrated in the computing system 334 or discrete components coupled to the system 334. In some embodiments, for example, signals are acquired simultaneously and/or sequentially from detectors 364, 374 and detectors 330, 332 (e.g., elements 360, 370 may include beam splitter elements).

It will be understood by one skilled in the art that various other suitable components may be employed in the implementation 350, such as hardware auto-correlator(s). Additionally and/or alternatively, other exemplary implementations of SFRS may adopt other suitable configurations utilizing part or all of the components disclosed herein. For instance, instead of the two photon-detection mechanisms demonstrated in the implementation 350, an exemplary implementation may include only the spectrometers and compatible detector(s) e.g., time-tagging single-photon cameras for the purpose of detecting scattered photons.

FIG. 3D is a schematic diagram 30 illustrating super-resolution image equivalents of the position of independently spectrally fluctuating Raman scatterers in an image plane, in accordance with some embodiments. As indicated by arrow 32, at an image plane of the SFRS optical system (e.g., at the sensing area of a detector (e.g., detectors 330, 332, and/or detectors 364, 374)), individual Raman scatterers 33a, 33b (e.g., corresponding to scattered photons 308 of specific Raman peaks) may be detected with their corresponding signal profiles (e.g., intensity, spectral, or power distributions). As shown in block 34, the Raman scatterer 33a may be represented by a first point-spread function, while the Raman scatterer 33b may be represented by a second point-spread function. A detector array 36 (e.g., SPAD array), comprising a plurality of sensing elements (e.g., pixels 1-7), may detect intensity (or power) distributions of the Raman scatterers 33a and 33b corresponding to their point-spread functions. In this example, the Raman scatterers 33a, 33b undergo independent spectral fluctuations.

As shown in block 38, spectral correlation probability between individual Raman scatterers (e.g., 33a and 33b) may be determined based on signals detected by individual pixels of the detector array 36. Diagrams illustrating the spectral correlation probability (P(ζ)) versus the spectral shift (ζ) based on detections by pixel 1 (or 6) and pixel 4 are provided as examples. In the example as depicted in block 34, pixel 1 (or 6) of the detector array 36 may only detect signals correspond to a single Raman scatterer 33a or 33b, while pixel 4 of the detector array 36 may detect signals with contributions from both Raman scatterers 33a, 33b.

In block 38, the diagram on the left illustrates that varying temporal separations (or lag time, τ) between photon pairs may result in different curve widths in the spectral correlation, indicating spectral shifts. Accordingly, with longer time-lag (later τ), the spectral correlation (associated with the probability on the y-axis) occurs over a broader range of spectral shift (ζ). On the other hand, with shorter photon lag-time (earlier τ), the spectral correlation (associated with the probability on the y-axis) occurs over a narrow range of spectral shift (ζ). The diagram on the right exhibits a similar trend to the diagram on the left. Albeit, for the earlier τ curve, there is an increased spectral correlation probability below a certain threshold (e.g., below which instances are defined as uncorrelated). This uncorrelated feature stems from the spectral correlation of two photons from the two independent Raman scatterers, which must be uncorrelated. By determining the spatial distribution of the degree of early τ correlation, the position of the two scatterers can be inferred.

FIG. 3E is a schematic diagram of another exemplary implementation of Spectral Fluctuation Raman Spectroscopy (SFRS), in accordance with some embodiments. For example, the exemplary implementation 40 may be configured to detect photons from one or more Raman scatterers (e.g., 42a and/or 42b). The scattered photons first propagate through a lens 44; lens 44 transforms signals from an image plane to a Fourier plane (e.g., in the spatial frequency domain). Subsequently, the photons are split into two optical paths (OP1 and OP2) by an optical component (e.g., a beamsplitter 46, a prism, a grating, or other suitable components). Other suitable optical components (e.g., mirrors 48a, 48b) are utilized to guide the photons to travel through the respective optical paths towards corresponding detectors (e.g., array detector 52a, 52b) for photo-detection. For instance, the array detectors 52a, 52b may be positioned at (or proximate to) the outputs of the respective optical paths. As indicated by arrow 54, the path length (or distance) of at least one optical path (e.g., OP1) may be adjusted over time, e.g., associated with δ corresponding to the center path length difference dᵢ. In some examples, the photons output from the optical paths (OP1 and OP2) are directly detected by the detectors 52a, 52b. To this end, the detectors 52a, 52b may be configured to detect and analyze signals on a Fourier plane. In some instances, lenses 50a, 50b may be disposed in front of the respective detectors 52a, 52b. As such, the detectors 52a, 52b may be configured to detect and analyze signals on an image plane, as the lenses 50a, 50b act as Fourier transformers similar to the lens 44. In some variations, the lenses 50a, 50b may be switchable (or adjustable) within the respective optical paths, so that the system implementation 40 may be controlled to operate at different modes, enabling the detection of signals in either the Fourier plane or the image plane.

According to embodiments, SFRS advantageously overcomes the key challenge of intrinsically low signal strengths of Raman spectroscopy in the limit of few or single molecules that currently limits the achievable time-resolution. The Raman cross-section of single molecules is about eight orders of magnitude lower than its electronic absorption cross-section. For the characterization of biomolecular dynamics e.g. of single proteins, SFRS must therefore operate with exceedingly high sensitivity and a suite of enhancement strategies. Methods of surface-enhanced Raman spectroscopy (SERS) that have previously enabled single-molecule Raman detection within short distances of plasmonic nanostructures are dramatically expanded upon using dielectric photonic nanostructures. Unlike plasmonic structures, dielectrics are low optical loss and provide high optical quality factors that can be advantageously harnessed to enhance the Raman scattering cross-section by orders of magnitude. In some instances, single molecules and proteins may be tethered to surface-enhanced Raman substrates of noble-metal and dielectric nanostructures, which is known to enhance the signal by many orders of magnitude to provide single-molecule sensitivity (as discussed in Langer et al. (2019), “Present and Future of Surface-Enhanced Raman Scattering,” ACS Nano 2020, 14, 1, 28-117). As such, the method of SERS may be enhanced by using the dielectric substrates that are low-optical-loss and operating at orders of magnitude higher excitation-laser intensities. In some variations, a confocal laser microscope collects the Raman scattered photons and tunable optical filters are used to select one (or two) Raman-lines of interest for SFRS analysis. In other examples, an imaging system comprising a confocal microscope, a wide-field imaging system or microscope, an epi-detection microscope, an atomic-force-microscope with optical access, a darkfield microscope, a phase contrast microscope, a stereo microscope, a polarization microscope, a polarization microscope may be utilized. For example, photon collection may be conducted in total-internal reflection geometry, reflection, and transmission. An optical interferometer encodes the spectral fluctuations into intensity fluctuations that are measured with transformative new single-photon detectors (as shown in FIG. 3B). In further examples, transformative advances in single-photon detection technology may be used in a SFRS instrument by co-designing SNSPDs recently brought to market. A SNSPD can detect single photons with up to >95% efficiency and with four orders of magnitude lower noise floor. The low noise is a truly game-changing advantage as even a few hundreds of Raman-scattered photons enable sufficient signal-to-noise to infer meaningful data on spectral fluctuations, unattainable with contemporary detectors. In other examples, a SFRS instrument may be built with high-throughput implementations, enabling analysis on an image rather than a point source. For example, the SFRS instrument may include one or more single-photon-sensitive detector arrays. Additionally and/or alternatively, the SFRS instrument may have an imaging implementation where the photons of a wide-field image are directed into an interferometer in the SFRS instrument. Then, the spectral fluctuation analysis may be performed for many pixels of one or more cameras (including single-photon cameras) located at the output arms of the interferometer.

Symbiosis with protein molecular dynamics simulations will multiply SFRS's impact. The combination of theory with SFRS is valuable in two ways; First, SFRS can help validate computational methods by providing the urgently needed experimental complement on nanoseconds to milliseconds. Second, simulations can inform the details of how to conduct SFRS experiments. SFRS essentially measures the frequency jitter of one (or two) Raman lines, informing on how the molecular environment of the associated scattering moiety imprints on the mode energy. Consequently, for a given system of study, Raman modes need to be identified that encode the dynamics of interest, such as the “closing” and “opening” hinge motion of a protein (e.g., depicted in FIG. 2B). In some instances, this can be achieved by first establishing how conformational dynamics imprint on Raman mode frequencies, and then extracting time-traces of the Raman frequencies of different sites in the same single protein by applying consecutive nuclear coordinate propagation using force-fields and Raman Eigenmode analysis.

In an embodiment, the technique disclosed herein may be utilized to investigate heat-shock protein 88 (hsp88), a widely studied model protein that allows validation of observed dynamics with results from different techniques and theory. Hsp88 has a tyrosine residue that acts as a molecular “tether” between larger subdomains in hsp88. The tyrosine Raman mode frequency may be responsive to conformational changes owing to the forces of aromatic interactions changing the equilibrium coordinates of the atoms involved in the vibration. While never analyzed dynamically, the effect of force-induced changes of the Raman frequency is known, with a few studies demonstrating the relationship between pico-Newton molecular forces, conformational crowding, and temperature on spectral shifts of Raman modes (as discussed in Kho, K. W., Dinish, U. S., Kumar, A. & Olivo, M. (2012), “Frequency Shifts in SERS for Biosensing,” ACS Nano 6, 4892-4902; Kuhar, N., Sil, S., Umapathy, S. (2021), “Potential of Raman spectroscopic techniques to study proteins,” Spectrochimica Acta Part A: Molecular and Biomolecular Spectroscopy, 258, 119712; and Artur, C., Le Ru, E., Etchegoin, P. (2011), “Temperature Dependence of the Homogeneous Broadening of Resonant Raman Peaks Measured by Single-Molecule Surface-Enhanced Raman Spectroscopy,” J. Phys. Chem. Lett., 2, 23, 3002-3005). In an exemplary embodiment, the dynamics of the Anti-Stokes Raman peak corresponding to a Tyrosine ring breathing mode (1016 cm⁻¹) are analyzed with an embodiment of a SFRS instrument. It will be recognized by those skilled in the art that the technique disclosed herein can be applied to various suitable frequency bands, such as the Stokes and Anti-Stokes lines of Tyrosine, and other amino acids. Aromatic moieties of amino acid residues are powerful natural probes, as their Raman bands are spectrally well isolated from other protein modes and can thus easily be selected for SFRS analysis (as discussed in Hu, X. & Spiro, T. G. (1997), “Tyrosine and Tryptophan Structure Markers in Hemoglobin Ultraviolet Resonance Raman Spectra: Mode Assignments via Subunit-Specific Isotope Labeling of Recombinant Protein,” Biochemistry 36, 15701-15712). SFRS compiles the energy difference of photon-pairs as a function of their time difference, effectively measuring how self-similar the Raman mode energy is over time. At small time differences between photons, the energy difference of photon-pairs reflects the homogeneous linewidth of the Raman line. In the limit of large time differences, the protein has undergone conformational dynamics, broadening the linewidth to the limit of steady-state Raman experiments. The intermediate time regimes, where conformational changes with different characteristic average switching times will lead to spectral fluctuations of the Raman band, demonstrate the power of SFRS. Spectral changes—here introduced phenomenologically for tumbling and folding—increase the energy difference of the photon-pairs. By dynamically resolving these energy differences, SFRS can recover the magnitude and timescales of conformational changes on sub-microseconds to milliseconds, otherwise obscured in single-molecule or single-protein measurements. This approach may be extended to the correlative analysis of multiple Raman peaks. By cross-correlating the spectral fluctuations of two vibrational modes corresponding to different sites of the same protein, a direct measure of the correlated conformational dynamics between different domains within the same protein may be obtained. In further embodiments, various analytical techniques and algorithms may be applied, allowing mapping of results onto molecular dynamics simulations, ultimately establishing a validated toolbox for accessing protein dynamics.

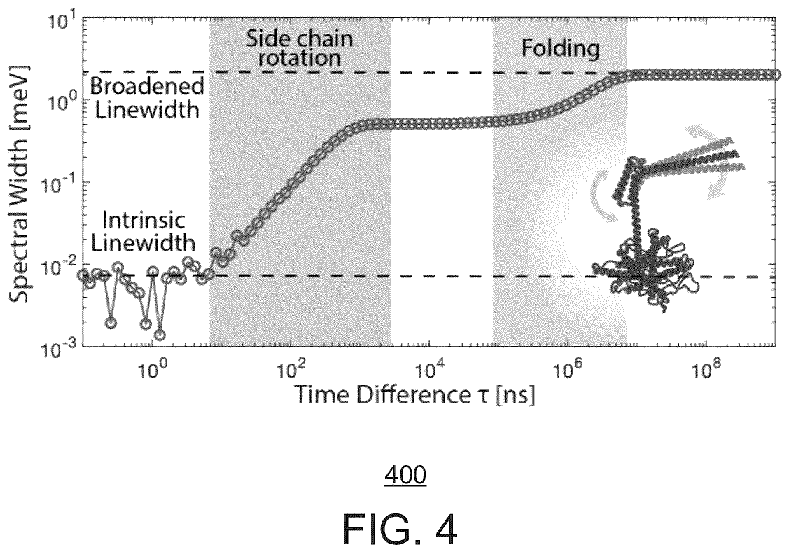

In some examples, the SFRS technique may implement a statistical optics model to simulate SERS observables based on the frequency fluctuations from molecular dynamics. In some instances, the SFRS technique may further implement Monte Carlo simulations of photons emitted and/or scattered from single-molecules (as discussed in 10. Utzat, H., Bawendi, M. (2021), “Lifetime-resolved photon-correlation Fourier spectroscopy,” Opt. Express, 29, 14293-14303), or other small objects so as to numerically compute the SFRS observable and ascertain the expected signal-to-noise and accessible time-resolution. FIG. 4 shows an exemplary and preliminary simulation, in accordance with some embodiments. The exemplary simulation 400 is based on phenomenological spectral shifts and rate-constants for molecular dynamics of hsp88. SFRS may be applied to measure the fast spectral shifts in the form of a correlation function, thereby recovering the magnitude and timescales of conformational changes on sub-microseconds to milliseconds. Ultimately, by closing the loop between molecular dynamics simulations, and statistical optics simulations like the one presented in FIG. 4, the full timescale protein conformational dynamics may be visualized, and the most promising Raman lines may be identified as reporters of dynamics for a given protein or other molecular system of interest.

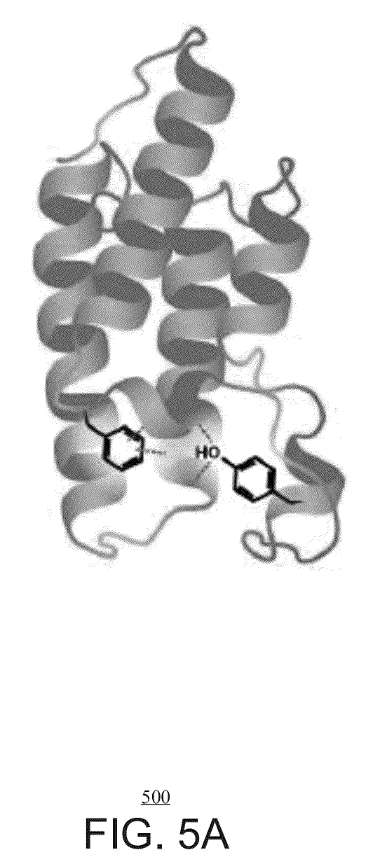

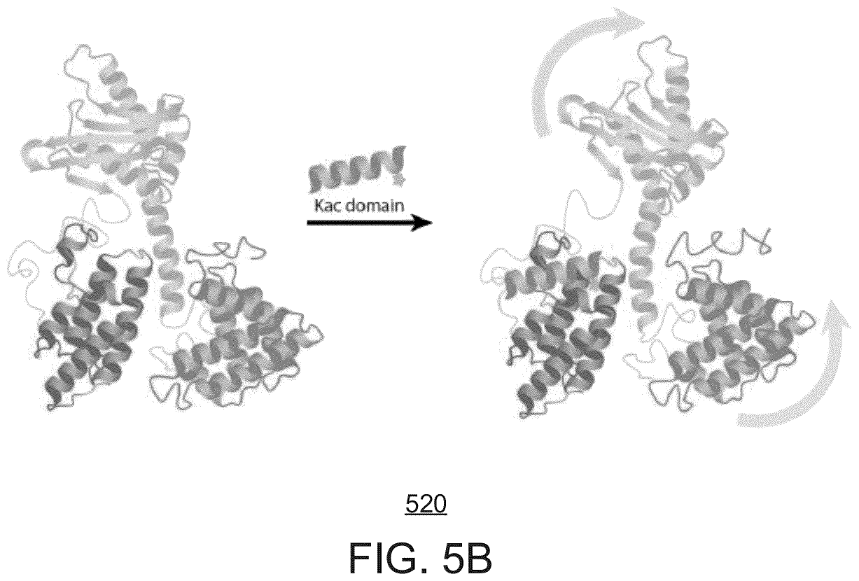

Following the validation of SFRS as a method of studying multi-timescale protein dynamics, its application to protein-protein interactions relevant to gene regulation is shown. DNA replication is modulated via proteins responsible for chromatin organization, mainly bromodomain-containing proteins (BCPs). BCPs act via recognition of acetylated lysine residues (Kac) in specific binding pockets referred to as “bromodomains.” This recognition regulates a vast, yet poorly understood range of physiological functions, including gene expression (as discussed in Dhalluin, C. et al. (1999), “Structure and ligand of a histone acetyltransferase bromodomain,” Nature 399, 491-496). BCPs can also become part of larger complexes driving yet higher order processes by serving as scaffolds controlling recruitment of other transcriptional regulators. However, understanding how BCP's complex, multi-domain machineries are driven by conformation dynamics across timescales is a key outstanding problem. This hierarchical nature of gene regulation is a promising target for SFRS inquiry; the ability to cross-correlate various protein domain motions over exceedingly wide temporal windows will prove enabling where other methods fall short in resolving BCP dynamics. The full-timescale conformational dynamics of bromodomains will be established before and after Kac binding. FIGS. 5A and 5B illustrate an exemplary SFRS analysis, in accordance with some embodiments. As shown in FIG. 5A, the SFRS analysis is performed on aromatic residues lining the bromodomain 500. Referring to FIG. 5B, diagram 520 shows that cross-correlation of the bromodomain spectral fluctuations with Raman modes of Kac will establish the time constants of Kac binding and concurrent BCP rearrangement. Once a firm understanding of the bromodomain is established, multi-domain BCPs may be studied and interdomain correlations may be interrogated to elucidate cooperative effects between the different domains. Here, the Raman spectral fluctuations of aromatic residues may be cross-correlated as local reporters in different protein domains (e.g., as depicted in FIG. 5B). Through theory-guided selection of suitable modes, how local binding of Kac affects the overall conformational dynamics of the BCP machinery may be shown. In a further embodiment, this knowledge may be used to probe protein-drug interactions. Potential small molecule drug candidates commonly contain aromatics not found in the proteins themselves with unique Raman spectral signatures, allowing for the cross-correlation of protein and drug signals. The detailed and unobscured observation of BCPs as they traverse complex free energy landscapes has the potential to enhance both an understanding of chromatin-associated DNA regulation mechanisms and the design of novel drugs effective in treating illnesses.

Techniques disclosed herein may be applied to other suitable applications, including protein sequencing.

In yet another embodiment, the application of SFRS to intrinsically disordered proteins (IDPs) relevant to more than half of the proteome is shown. IDPs have long received little attention due to their fluxional nature and the concomitant difficulty in crystallization and study by conventional methods. More recently, the structural versatility in different cellular contexts displayed by IDPs is rapidly implicating them at the center of widespread pathologies, from neurodegenerative diseases such as amyotrophic lateral sclerosis (ALS) to cancer (as discussed in Kulkarni, P. et al. (2022), “Intrinsically Disordered Proteins: Critical Components of the Wetware,” Chem. Rev., 122, 6, 6614-6633). Development of these pathologies is known to involve the formation of higher-order assemblies of IDPs e.g., organelles or amyloid fibers. However, a major missing key is foundational knowledge of how the native conformational dynamics of single IDPs can drive the formation of these larger assemblies in the diseased state. The even less well-understood parameter space compared to structured proteins excludes many single-molecule techniques such as “molecular rulers” based on gold nanoparticles or dye labeling, which can only measure few intramolecular distances, which also need to be well-defined prior to protein labeling. Here, SFRS is a truly uniquely suited tool for the more explorative studies of the IDP conformational dynamics.

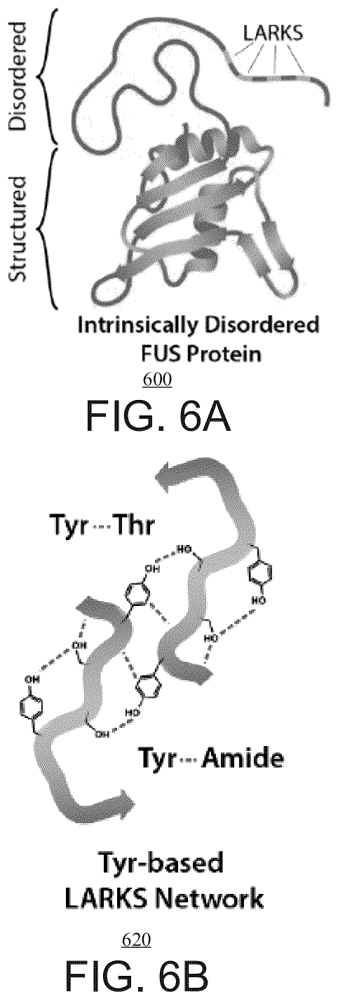

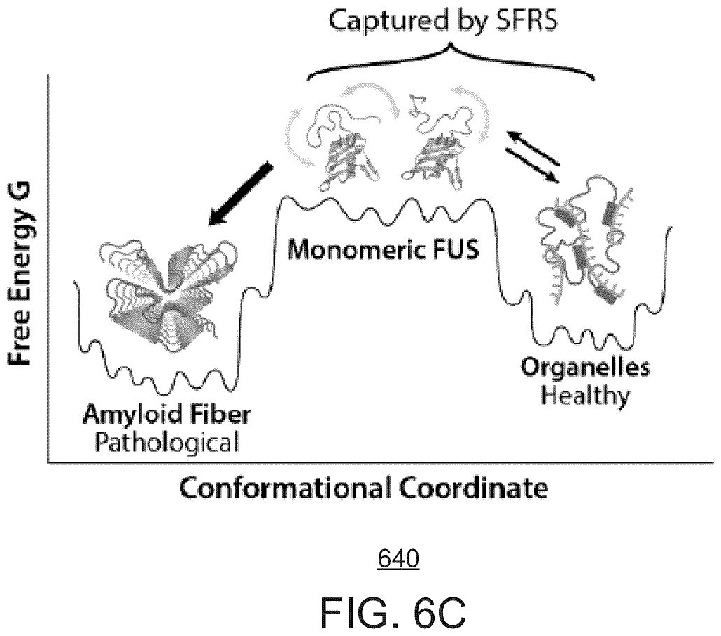

In one embodiment, SFRS may be utilized to illuminate the behavior of Fused in Sarcoma (FUS) proteins. FIG. 6A shows an exemplary FUS protein, in accordance with some embodiments. The FUS protein 600 comprises an intrinsically disordered region (IDRs) and protein and RNA binding sites (as discussed in Chen C., Ding X., Akram N., Xue S., Luo SZ. (2022), “Fused in Sarcoma: Properties, Self-Assembly and Correlation with Neurodegenerative Diseases,” Molecules. 24;24(8):1622). FIG. 6B shows an exemplary Tyr-based low-complexity aromatic-rich kinked segments (LARKS) network, in accordance with some embodiments. The LARKS network 620 may be part of the FUS protein 600 as depicted in FIG. 6A. A study may focus on so-called low-complexity domains (LCDs), repetitive sequences common to IDRs, which show specific binding patterns. Both wild type and mutant FUS can form reversible hydrogels through labile, low-complexity aromatic-rich kinked segments (LARKS), as well as aggregates and potentially fibrillar structures causing neurodegenerative disorders like ALS. One of the main open questions is how external stimuli, for example RNA binding in the structured domain, affect the conformational dynamics of the whole protein. FIG. 6C is a diagram illustrating exemplary conformational dynamics observable by SFRS, in accordance with some embodiments. Single-molecule or few molecule SFRS may be used to delineate these conformational dynamics (depicted in the diagram 640) of FUS domains bound or unbound to secondary entities. In an example, the single-molecule SFRS may include a step of cross-correlating the Raman peaks from the IDR and binding agent to establish how structural changes in one domain affect the dynamics of other domains. LARKS are stabilized through aromatic stacking and hydrogen bonds forming β-sheets, but the underlying equilibrium constants, timescales and mechanistic details are virtually unknown. The chemical selectivity of SFRS helps to delineate the dynamics of various parts of LARKS towards a comprehensive picture of how this critical protein motif changes over time. These cross-correlative SFRS studies will be performed with RNA and heat-shock protein, known to form complexes with FUS. Together with theory discussed above, these studies will identify the conformers and their thermodynamics responsible for driving the formation of pathological assemblies beyond what is currently possible. Ultimately, SFRS may be used to gain a comprehensive understanding of IDPs in vitro, as well as to study IDPs under the influence of chemical and biological stimuli found in cellular environments, thus charting a way forward in understanding their higher order assembly and pathology.

SFRS advantageously provides a new tool for conformational studies across most relevant timescales, down to the single-molecule level, and without the need for labels. Correlating spectral signatures of different protein sites' Raman modes will provide unprecedented versatility for the study of how biological function emerges from correlated protein domain motion. Such analysis has yet unforeseen impact in all areas of biomedical science and will further address the current lack of experimental techniques to validate theoretical efforts on protein dynamics and folding using molecular dynamics. A long-term prospect is establishing combined experimental/theoretical projects elucidating not just when conformational changes are occurring, but precisely how atomic coordinates transform through time to produce biological action and how this action can be rationally controlled.

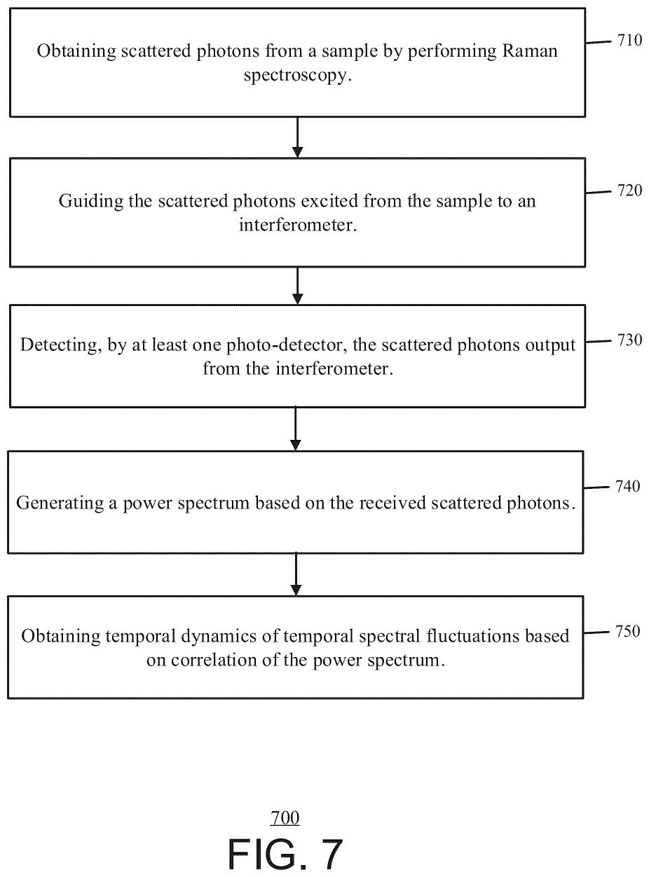

FIG. 7 is an exemplary process 700, in accordance with some embodiments of the present disclosure. The process 700 may be performed by a SFRS system. The SFRS system may include one or more devices or systems for measurement/detection. For instance, the SFRS system may include a light source to excite a sample, a lens system to reflect and/or refract light, one or more detectors for light detection, and various other suitable devices/systems. The light source may be a coherent light source, such as a gas laser, a laser diode, etc. The light source may be tunable in intensity and/or wavelength. In some instances, the light source may be a continuous laser source or a pulsed laser source. The lens system may include one or more optical microscopes, optical filters, various types of lenses and mirrors, and/or suitable waveguides (e.g., optical fibers), to facilitate Raman spectroscopy and/or interferometry. One or more optical filter elements may include a grating spectrometer, a prism element, a refractive element, a diffractive element, or other dispersive element. The detector may be a photo-detector of various types, such as a superconducting nanowire single-photon detector, a photo-multiplier tube, an avalanche photo-diode, a detector array, a CMOS detector, an EMCCD detector, or a combination thereof. In some variations, the SFRS system may include a Raman spectroscopy instrument, an optical interferometer instrument or a combination thereof to perform the corresponding measurements. In such configurations, the light source, lens system, and/or detector(s) may be built into the Raman spectroscopy and/or interferometer instrument. In a further example, the SFRS system may include or be commutatively coupled to a computer system for controlling measurements and/or data processing.

At step 710, the SFRS system obtains scattered photons from a sample by performing Raman spectroscopy. The Raman spectroscopy may be Surface-Enhanced Raman spectroscopy (SERS), Tip Enhanced Raman spectroscopy (TERS), Surface Plasmon Polariton Enhanced Raman spectroscopy (SPERS), Surface Enhanced Resonance Raman spectroscopy (SERRS), Coherent Anti-Stokes Raman Spectroscopy (CARS), Resonant Raman Spectroscopy, Stimulated Raman Spectroscopy, tip-enhanced Raman spectroscopy, or based on other suitable Raman spectroscopy techniques. In some examples, the Raman spectroscopy may use quantum states of light, including phase and amplitude squeezed states as well as states of entangled photons.

In some examples, the sample may have dielectric or metallic photonic nanostructures, e.g., nanowires, nanoparticles, quantum dots with periodic or aperiodic structures. The sample may include molecules, proteins, DNA strands, RNA strands, or combinations or complexes thereof. The sample may include exosomes, viral particles, extra-cellular vesicles, or bacteria. The sample may include Raman-active contrast agents, including Allyl-based tags and other dyes, in biological cells or other environments. The sample may further be a cell, or biological tissue containing SERS-tags based on nanoparticles, such as plasmonic gold or silver particles. In some examples, the sample may include oligomers or polymers, including nanobeads, drug-delivery vesicles, organic electronics, 3D printed organic materials, rubbers, etc. As discussed above, the SFRS system may achieve “label-free” measurement schemes. However, it will be recognized by those skilled in the art that the technique disclosed herein can be applied to samples with labels as well. For example, the sample may include covalently bound or free isotope labels with shifted vibrational frequencies, allowing the study of specific chemical moieties of the sample. For another example, the sample may include covalently bound or free Raman labels.

In some instances, the sample may include a semiconductor material/device, and/or ceramic material. In some variations, the sample may include artwork, paintings, paper-based materials, fabric, or paint, or pigments.

The sample may include complex mixtures of biological molecules and particles with the objective of characterizing and separating the mixture's constituents. The sample may contain pollutants, soil or soil constituents, water, or atmospheric aerosols. The sample may include pharmaceuticals or pharmacologically active substances. The sample may include organic tissue, tissue slices, or cell cultures.

The light source of the SFRS system may be incident on the sample to excite the sample to generate the scattered photons. The wavelength of the incident light and the frequency of the scattered photons may be related to energy bands (e.g., Raman bands) of the sample. For example, the energy bands of the sample may indicate conformational dynamics of spectral fluctuations on timescales as shown in FIG. 1. The scattered photons may indicate temporal spectral fluctuations.

In further examples, the SFRS system may include one or more optical filters that are used to select between a plurality of Raman bands. In an exemplary implementation, the one or more optical filters may be disposed between the sample and the interferometer in the SFRS system.

In some variations, the SFRS system may implement a frequency-tunable continuous wave (CW) laser source. During operation, the sample may be illuminated by the CW laser with a variable wavelength to induce excitation of different Raman modes, which may be analyzed later by an interferometer. By implementing a frequency-tunable CW laser, the detection wavelength of the Raman system, e.g., the detection wavelength or wavelength of photo-detector(s) may be set to be constant or within a predefined range.

In some embodiments, photons to be analyzed, such as Raman scattered photons, may be collected from a well-plate, semiconductor chip containing biological molecules or samples, a micro-or nano-fluidic channel containing analyte molecules, a nanopore architecture used to sequence biomacromolecules such as proteins or DNA/RNA. The photons to be analyzed, such as Raman scattered photons, may be collected from a sample comprising proteins or nucleotide sequences and collecting the spectral correlation during the administration of chemical or biological agents such as enzymes to the sample of proteins so as to determine the sequence of the protein of nucleotide sequence.

At step 720, the SFRS system guides the scattered photons excited from the sample to an interferometer included in the SFRS system. The interferometer may have a first optical path and a second optical path.

As shown in FIG. 3B, a beamsplitter or a similar optical component may be utilized to guide, or cause the scattered photons to propagate, through either of the first and second optical paths. The distance of the optical path, e.g., the distance between the point of incidence on a beamsplitter and the point of incidence on a receiver (e.g., on a sensing element of a photo-detector), may affect the intensity of light at a particular wavelength or range of wavelengths. At least the distance of one of the first and second optical paths may be tunable. The distance of the optical path may be adjusted in accordance with the energy bands of the sample.

In some instances, the SFRS system may adjust the distance of the first and/or second optical path to a plurality of lengths during measurement. For example, the SFRS system may adjust the length of the first optical path to a first distance to take measurements, and may adjust the length of the first optical path to a second distance to take subsequent measurements. In a further example, the first distance and the second distance may be periodically changed, e.g., by distances of up to a multiple of the wavelengths of the scattered photons. In some variations, the SFRS system may (smoothly or in a stepwise manner) sweep a length of the first and/or second optical path over a predefined incremental distance. In addition, the SFRS system may detect the output of the interferometer with a predetermined integration time(s).

At step 730, the SFRS system detects the scattered photons output from the interferometer by using at least one photo-detector.

In one exemplary configuration, the SFRS system may include a single photo-detector. The SFRS system may include optical components to guide the output of both the first and second optical paths of the interferometer to the photo-detector in the SFRS system. In another exemplary configuration, the SFRS system may include two photo-detectors. Each photo-detector may be placed at the output of one of the two optical paths of the interferometer. In yet another configuration, the SFRS system may include two or more photo-detectors. More than one photo-detector may be placed at the output of at least one of the two optical paths of the interferometer. For instance, multiple single-photon cameras may be placed at the first and second outputs of the interferometer, which correspond to the first and second optical paths, respectively. Such implementations may facilitate higher-throughput analysis of samples in some circumstances. In an exemplary embodiment, the SFRS system may be built with high-throughput implementations, enabling analysis on an image rather than a point source. For example, the SFRS system may include one or more single-photon-sensitive detector arrays (e.g., single-photon cameras).

Additionally and/or alternatively, the SFRS system may have an imaging implementation where the photons of a wide-field image are directed into an interferometer in the SFRS system. As such, the SFRS system may perform the spectral fluctuation analysis for many pixels of one or more cameras located at the output arms of the interferometer.

In some embodiments (e.g., as shown in FIGS. 3D and 3E), spatially-resolved SFRS analysis is used to obtain a super-resolved image equivalent of two Raman scatterers in the sample plane. Any imaging system can be used to obtain Raman photons from spatially-dispersed Raman scatterers. These photons are directed into the SFRS interferometer to be mapped onto two array-detectors at the output arm. FIG. 3D shows how pixel-wise auto-or cross-correlation at different center interferometer positions recorded under select path-length dithering identifies the spatially-resolved spectral correlation can reconstruct an image. The evolution of the spectral-correlation over the lag time (τ) is dependent on the ratio of photons from the same (dependently spectrally fluctuating) and different (independently spectrally fluctuating) Raman scatterers. The spatial map of the corresponding features in the spectral correlation function can be used as additional information to localize the two or more Raman scatterers in the object plane, thus forming a super-resolved image equivalent. This method can be understood as a spectral fluctuation equivalent of the intensity fluctuation contrast mechanism used in Super-Resolution Optical Fluctuation Imaging (SOFI).

In another exemplary configuration, the SFRS system may have an imaging implementation where photons of a wide-field image are directed into an interferometer in the SFRS system and detected in the Fourier plane (e.g., conjugate plane) of the sample plane to relate some characteristic features of the sample to spectral fluctuations. Accordingly, the spatial resolution may be obtained in either the image plane or Fourier (conjugate) plane of the sample plane of the imaging lens collecting Raman scattered photons.

In some instances, the at least one photo-detector of the SFRS system detects the scattered photons with time-tags. A time tag (or time stamp) may be associated with the time of arrival of a corresponding photon detected by the photo-detector. That said, the at least one photo-detector may detect each individual photon with the time of arrival thereof. In an embodiment, the SFRS system may determine and store a time of arrival for each photon detected by a photo-detector in the SFRS system. In some examples, the intensity-correlation may be performed using algorithmic correlation of photon-arrival time-tagged data.

The at least one photo-detector in the SFRS system may include various types of detectors, such as a superconducting nanowire single-photon detector, a photo-multiplier tube, an avalanche photo-diode, a detector array, or any combination thereof.

Various parameters of the at least one photo-detector, e.g., the integration time and pose of the detector, may be adjusted manually or automatically. For instance, the detector may be placed on a motorized translation stage, which may be controlled by the computer system.

At step 740, the SFRS system generates a power spectrum based on the received scattered photons by the at least one photo-detector. The power spectrum translates the temporal spectral fluctuations into temporal intensity fluctuations. As such, the power spectrum may indicate temporal intensity fluctuations recorded by the at least one photo-detector based on the received scattered photons at the at least one photo-detector. In some examples, the computer system of the SFRS system may apply suitable algorithms to generate the power spectrum, for example to perform fitting and/or optimization. The computer system may generate one power spectrum for each photo-detector. In some variations, the computer system may merge the power spectrums from multiple photo-detectors to generate a combined power spectrum.

The computer system of the SFRS system may perform a correlation on the generated power spectrum to obtain the temporal dynamics of the temporal spectral fluctuations. For instance, the computer system may automatically correlate the power spectrum by performing an intensity-correlation analysis of the intensity fluctuations at different interferometer settings or positions.

In a further embodiment, the computer system may correlate two vibrational modes corresponding to different sites of the sample, thereby obtaining a correlated motion between different domains within the sample.

The power spectrum may indicate energy difference of photon-pairs as a function of time difference thereof. Each photon-pair may include a photon received by the at least one photo-detector from the first optical path and another photon received by the at least one photo-detector from the second optical path.

At step 750, the SFRS system obtains temporal dynamics of temporal spectral fluctuations based on correlation of the power spectrum. The computer system of the SFRS system may perform various analysis based on the generated power spectrum. In one example, the computer system may analyze the scattered photons based on dynamics of an Anti-Stokes Raman peak corresponding to a Tyrosine ring breathing mode. The analysis may be extended to other Raman modes for other suitable samples, for example, Stokes or Anti-Stokes Raman peaks of various amino acids, labels, or moieties. In another example, the computer system may analyze the scattered photons for multiple Raman peaks, e.g., the Stokes and/or Anti-Stokes Raman peaks. In yet another example, the computer system may implement various analytical techniques and algorithms to map measurements to simulations (e.g., molecular dynamics simulations), thereby establishing a validated toolbox, e.g., for accessing protein dynamics. In addition, the computer system may interact with a database storing similar or related data. The computer system may perform various operations to interact with the database, for example by uploading measurement results from the SFRS system to the database, or downloading relevant information to analyze, optimize, or predict measurements. The database may be stored locally or on cloud servers, which may be publicly available or private.

In some variations, the computer system may form an image or images of the temporal dynamics of the temporal spectral fluctuations.

FIG. 8 illustrates a block diagram of an exemplary computer system 800 configured to implement various functions according to one or more embodiments in the present disclosure.

As shown in FIG. 8, the computer system 800 may include one or more processors 810, a communication interface 840, a memory 820, and a display 830. The processor(s) 810 may be configured to perform the operations in accordance with the instructions stored in the memory 820. The processor(s) 810 may include any appropriate type of general-purpose or special-purpose microprocessor (e.g., a CPU or GPU, respectively), digital signal processor, microcontroller, or the like. The memory 820 may be configured to store computer-readable instructions that, when executed by the processor(s) 810, can cause the processor(s) 810 to perform various operations disclosed herein. The memory 820 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM.

The communication interface 840 may be configured to communicate information between the computer system 800 and other devices or systems, such as motorized translation stages, detectors, cloud servers, etc. For example, the communication interface 840 may include an integrated services digital network (“ISDN”) card, a cable modem, a satellite modem, or a modem to provide a data communication connection. As another example, communication interface 840 may include a local area network (“LAN”) card to provide a data communication connection to a compatible LAN. As a further example, communication interface 840 may include a high-speed network adapter such as a fiber optic network adaptor, 10G Ethernet adaptor, or the like. Wireless links can also be implemented by the communication interface 840. In such an implementation, the communication interface 840 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

The communication interface 840 may also include various I/O devices such as a keyboard, a mouse, a touchpad, a touch screen, a microphone, a camera, a biosensor, etc. A user may input data to the computer system 800 (e.g., a terminal device) through the communication interface 840.

Raman Spectroscopy is a powerful and ubiquitous analytical technique in the chemical and biological sciences relying on inelastic scattering of photons off the analyte and providing a spectral fingerprint characteristic of the chemical or biological structure. Still, two main problems hinder the more wide-spread application of Raman spectroscopy. First, Raman is an inherently weak process requiring sensitive detection methods, and/or various enhancement strategies (including surface enhancement of electric fields, enhancement of the Raman cross-section via addressing resonant electronics states, or stimulation of the Raman process with secondary laser beams), on the level of single-molecule Raman. Low signal strength often precludes fast signal acquisition, in particular for small sample amounts and certainly in the limit of single molecules. Second, Raman often co-occurs with background fluorescence, especially in biological samples. As fluorescence is an orders-of-magnitude brighter process, it often obfuscates the Raman signal making unambiguous signal assignments complicated.

To solve these problems, the present disclosure adopts a conceptually new way of i) accessing in principle arbitrarily fast timescales in Raman spectroscopy, and ii) removing the effect of background fluorescence, by implementing time-correlated detection of Raman-scattered photons. The intensity-correlation—or photon-correlation—function of Raman scattered photons informs on the self-similarity of the scattering medium—or the scattering entity over a wide dynamic range from nanoseconds to many seconds. The intensity correlation can be achieved irrespective of whether a continuous-wave (CW) laser or a pulsed (or time-modulated) light source is employed.

In a further embodiment, a time-gated detection of Raman-scattered photons under pulsed laser detection can further eliminate the effects of autofluorescence because fluorescent photons are generated with a typically nano-second long delay, whereas Raman-scattered photons are created instantaneously with the laser pulse.

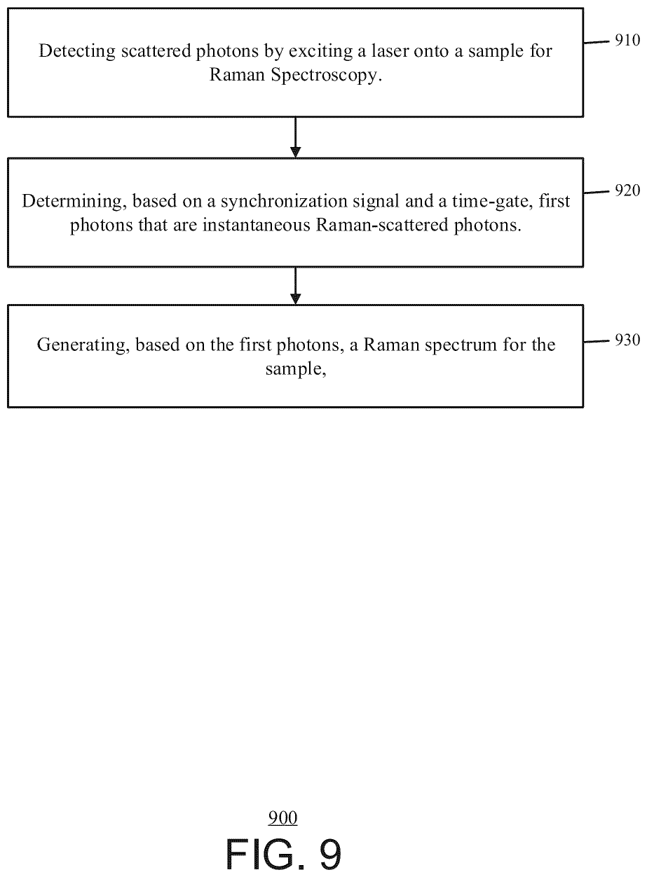

FIG. 9 is an exemplary process 900 in accordance with one or more embodiments of the present disclosure. The process 900 may be performed by a Raman spectroscopy system (e.g., the SFRS system) disclosed in the present disclosure.

For example, the Raman spectroscopy system may include a pulsed laser or a time-modulated laser (e.g., by utilizing an optical chopper) to excite a sample. The wavelength of the pulsed laser may be determined by the specific application. For example, wavelengths such as 532, 638, and 980 nm are commonly used. Pulse width and repetition rates are highly variable. In some examples, the Raman spectroscopy system may utilize a picosecond or nanosecond pulse width laser that has a narrow spectral bandwidth, which allows for a higher resolution in SFRS. In some instances, the Raman spectroscopy system may implement single-photon sensitive detectors, including superconducting nanowire single-photon detectors (SNSPDs), avalanche photodiodes, and photomultiplier tubes, for intensity-correlation Raman spectroscopy. The detectors in the Raman spectroscopy system may be point-like, line-like, or array-like detectors. In particular, SNSPDs with exceptionally high timing resolution and low dark counts will enable the faithful detection of Raman scattered photons and their correlation through hardware intensity-correlators or with software in post-processing.

At step 910, the Raman spectroscopy system detects scattered photons by exciting a laser onto a sample for Raman spectroscopy. As mentioned above, the laser may be a pulsed or time-modulated laser, so that the output optical power appears in pulses of a specific duration at a specific repetition rate. The Raman spectroscopy system may determine one or more synchronization signals based on the pulses generated by the laser. For instance, the Raman spectroscopy system may utilize all pulses or every other pulse (or other suitable settings) as a synchronization signal. In such configuration, the time of laser excitation is encoded in the synchronization signal.

In an embodiment, the Raman spectroscopy system may utilize an interferometer to obtain/analyze the scattered photons, for example, by performing steps 710, 720, and 730 of the process 700, as shown in FIG. 7.

At step 920, the Raman spectroscopy system determines first photons that are instantaneous Raman-scattered photons based on a synchronization signal and a time-gate. The time-gate may be set in hardware, depending on the photon-detector used, or in software (e.g., during post-processing). In general, a narrow time-gate after the synchronization signal from the pulsed laser might be chosen to select instantaneously Raman-scattered photons from any fluorescent background.

The synchronization signal is a time-domain signal and does not relate to any spectrum. The repetition frequency of the synchronization is set by the type of laser chosen for the sample under study. For a given set of photons detected with a time stamp, the synchronization signal is used as a filter function to get a new set of time-stamped photons. The time-domain correlation is then obtained from the new, filtered set of photons.

On the other hand, the background photons (e.g., fluorescent photons) are generated with a time delay relative to the laser excitation (that is time-encoded). Photons detected close to the laser excitation likely correspond to Raman photons, whereas delayed photons may stem from background, generated by slower fluorescence processes.

In an embodiment, the Raman spectroscopy system may perform an intensity correlation (equivalent to photon-correlation) analysis of the detected photons to extract fast intensity fluctuations of the Raman-active sample. Based on the intensity correlation analysis, the Raman spectroscopy system may determine the time-domain correlation between the detected photons and a synchronization signal from the pulsed laser source. The time-delay between the pulsed laser source and the detected photons being used for the separation of Raman-scattered photons and background photons from the sample. In some instances, the Raman spectroscopy system may determine that the particular scattered photons are the first photons, based on the time differences associated with the particular scattered photons within the time gate. Additionally, the Raman spectroscopy system may determine that particular scattered photons are second photons that are background photons, based on the time differences associated with the particular scattered photons beyond the time gate. In some variations, the Raman spectroscopy system may filter out the second photons.

At step 930, the Raman spectroscopy system generates, based on the first photons, a Raman spectrum for the sample.

Process 900 (involving intensity correlations) may be implemented in the SFRS system described in the present disclosure to increase the signal-to-background for an SFRS measurement. Additionally, intensity-correlations as described in process 900 may be applied to other applications in the characterization of biological dynamics, which can be probed with Raman intensity-correlation independently of SFRS. In some examples, process 900 may be applied to analytes in liquid samples, where the intensity fluctuations encode diffusion dynamics in a Raman-equivalent of fluorescence-correlation spectroscopy.

The measurements (e.g., the Raman photon-correlation and SFRS) disclosed herein may be performed under very low photon fluxes (e.g., dozens per second) enabled by superconducting low noise detectors. Additionally and/or alternatively, superconducting nanowire single-photon cameras may be used for high-throughput and on-chip measurements.

In some examples, instead of using an interferometer, the SFRS may use a spectrometer coupled with a single-photon camera, each pixel performing a photon-correlation, thus providing a spectrally-resolved correlation function.

In further examples, super-resolution imaging may be performed using spatio-temporal SFRS analysis with single-photon counting cameras.

The systems, apparatuses, and methods disclosed herein utilize Raman spectroscopy as an example. It will be understood by one skilled in the art that other spectroscopic techniques, such as fluorescence spectroscopy and the scattering off plasmonic particles or antennas hosting surface-plasmon resonances (SPPs), can be utilized and benefit from the present embodiments by applying the essence of the present disclosure to other signals, such as fluorescence spectroscopy signals. This can for example be used to study proteins, peptides, or oligonucleotides labeled with fluorescent emitters, so as to identify their dynamics. In some examples, the spectral fluctuations in the fluorescence of emissive labels (induced either by changes in the local environment of the label—just like for the detailed case of Raman spectroscopy—or energy transfer to different electronic states residing on the same or different emissive molecules) may be used as additional information to support the determination of the sequence of bio-macromolecules. In some examples, this may be achieved by performing temporal multiplexing of fluorescent labels bound to complementary DNA strands based on different characteristic fluctuation dynamics. In yet other examples, monitoring the spectral self-similarity of labels used as markers in peptide or protein sequencing, e.g., while attaching with some characteristic kinetics to the termini of proteins, peptides, or poly-amino-acids during treatment with enzymes or chemicals leading to their degradation, may improve the precision and speed of such sequencing methods. In some examples, the scattering off plasmonic particles or antennas can be modulated in frequency by molecular fluctuations of bound (or otherwise vicinal) entities e.g., proteins, other plasmonic particles, or labels.

In some examples, some or all of the data analysis, such as intensity correlation or the identification of the instantaneous scattered photons, according to example embodiments of the present disclosure, may involve an artificial intelligence (AI) or Machine Learning (ML) algorithm or process, such as a neural network (NN). A NN includes multiple layers of interconnected nodes (e.g., perceptrons, neurons, etc.) that can be trained with enormous amounts of input data to quickly solve complex problems with high accuracy. The first layer in the NN, which receives input to the NN, is referred to as the input layer. The last layer in the NN, which produces outputs of the NN, is referred to as the output layer. Any layer between the input layer and the output layer of the NN is referred to as the hidden layer. The various layers in the NN may be trained to break down the input (e.g., the power spectrum) into multiple sections and learn the correlation between the sections, thus allowing the model to identify the signals of interest (e.g., specific Raman peaks). The NN may be fully connected or include a conventional NN (CNN) or a recurrent neural network (RNN). The parameters/weights related to the NN may be stored in memory 820 of a computer system 800 (as depicted in FIG. 8) in the form of a data structure, which may be executable by processor(s) 810 to facilitate the operation of the NN. In some examples, the NN may be trained to process the information (e.g., corresponding to the fluctuations/dynamics) in the Fourier (conjugate) plane to obtain the spatial position of Raman scatterers in the image plane. Such analysis in the Fourier domain can be more effective in obtaining this reconstructed image equivalent than analysis in the image plane.

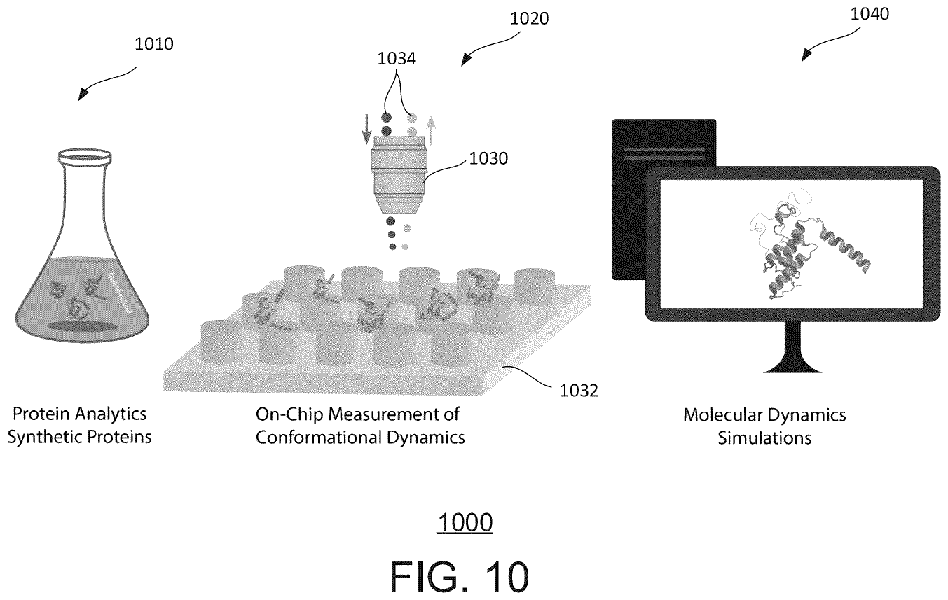

FIG. 10 shows an exemplary Raman assay, in accordance with some embodiments. As depicted in schematic diagram 1010, SFRS may be employed for peptide or protein analytics of synthetic proteins. An exemplary measurement setup is illustrated in schematic diagram 1020. In diagram 1020, sample 1032 may be prepared by attaching proteins (e.g., as depicted in diagram 1010) to a substrate with patterned structures. Photons excited from the sample 1032 (e.g., from the proteins and/or other background materials) may be detected (and analyzed) by an SFRS system (represented by the objective lens 1030). This system configuration enables on-chip measurement of conformational dynamics. As illustrated in diagram 1040, a computing system (e.g., the computing system in the SFRS system) may be utilized to analyze the measured data, as well as generate molecular dynamics simulations.

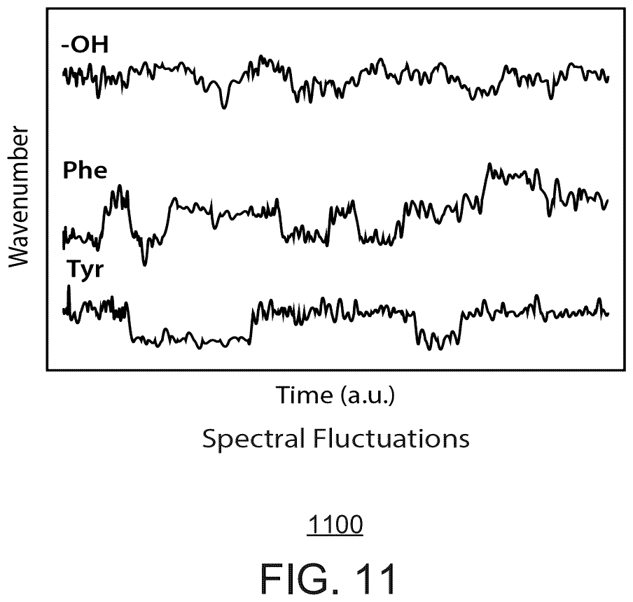

FIG. 11 shows exemplary spectral fluctuations, in accordance with some embodiments. As shown in the diagram 1100, various elements/components (e.g., —OH, Phe, Tyr) within proteins may correspond to distinct Raman peaks in wavenumber. The spectral fluctuations of —OH, Phe, Tyr may be acquired by using any of the SFRS systems disclosed in the present disclosure. In some embodiments, the measurement results may be correlated with simulations results.

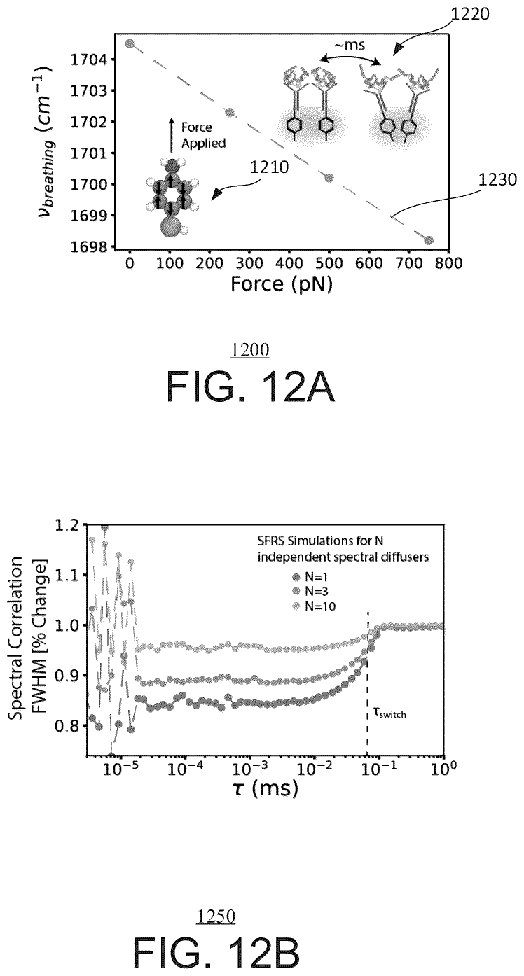

FIGS. 12A and 12B are exemplary simulation results, in accordance with some embodiments. FIG. 12A is a diagram 1200 illustrating the simulated dependence (e.g., by the dots and dashed line 1230) of the Raman shift of a molecule with the applied force. For example, as indicated by arrow 1210, fluctuating forces along the direction of the arrow e.g., from the motion of an attached analyte (e.g., protein), may induce changes (e.g., Raman shifts) in the molecule (as indicated by arrow 1220). Such a molecule can be used in a SERS assay of molecular dynamics (e.g., as illustrated in FIG. 10). Additionally, the diagram further shows an exemplary numerical simulation of the evolution of the fullwidth at half-maximum of the spectral correlation for a SERS assay of biomolecular dynamics.

As proteins are binding and unbinding to surface antigens (or nanobodies), they exert a force on the Raman tether resulting in spectral fluctuations. Similar fluctuations in the Raman tether can be invoked by the conformational dynamics of already surface-bound proteins. FIG. 12B shows exemplary SFRS simulations for a number (N) of Raman tethers. The numerical simulation shows, phenomenologically, how the independent fluctuation of a number (N) Raman tethers carrying antibodies and/or proteins undergoing conformational switching with a characteristic switching time of τ_switch translates to the SFRS observable. True single-molecule dynamics can still be observed if small sub-ensembles e.g. N=10 are measured. An inflection in the width of the spectral correlation of the Raman breathing mode of the tether molecule is observed at the characteristic switching time. Only the amplitude is modulated with changing average number of molecules, from which the signal is collected from.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising,” “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods/processes described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1.-3. (canceled)

4. A Raman spectroscopy system, comprising:
a source of Raman scattered photons;
an interferometer, the interferometer having a first optical path and a second optical path, wherein the Raman scattered photons traverse the first optical path and the second optical path, wherein different interferometer positions are obtained by changing a path length of the first optical path during a data acquisition time interval, wherein the interferometer system transcribes temporal spectral fluctuations of the scattered photons to temporal intensity fluctuations;
at least one photo-detector configured to detect the Raman scattered photons output from the first optical path and from the second optical path during the data acquisition time interval; and
a processor coupled with the at least one photo-detector and configured to determine a spectral correlation function based on an intensity-correlation analysis of the temporal intensity fluctuations at the different interferometer positions.

5. The system of claim 4, wherein the processor is further configured to determine the spectral correlation function by:
generating a power spectrum based on the detected scattered photons, the power spectrum indicating the temporal spectral fluctuations of the scattered photons detected by the at least one photo-detector; and
obtaining, based on correlation of the power spectrum, temporal information of the temporal spectral fluctuations at the different interferometer positions.

6. The system of claim 4, wherein that the path length of the first optical path is changed during the data acquisition time interval includes one of:
changing the path length of the first optical path in a continuous manner,
changing the path length of the first optical path in a step-wise manner, or
increasing and/or decreasing the path length of the first optical path in a controlled manner.

7. (canceled)

8. (canceled)

9. The system of claim 4, wherein the processor, or a separate processor, controls an adjustment mechanism coupled to a mirror element in the first optical path to dither or to adjust the path length of the first optical path in a controlled manner.

10. (canceled)

11. (canceled)

12. The system of claim 4, wherein the at least one photo-detector includes a first photo-detector configured to detect photons output from the first optical path, and a second photo-detector configured to detect photons output from the second optical path.

13. The system of claim 12, wherein the first photo-detector and the second photo-detector each includes a superconducting nanowire single-photon detector (SNSPD) element, or arrays thereof or a single-photon avalanche diode (SPAD) array detector element.

14. (canceled)

15. The system of claim 4, wherein the at least one photo-detector includes a first photo-detector pair configured to detect photons output from the first optical path and the second optical path, and a second photo-detector pair configured to detect photons output from the first optical path and the second optical path, wherein the system further includes one or more optical elements configured to direct and/or redirect photons output from the first optical path and the second optical path to the first photo-detector pair and the second photo-detector pair in a controlled manner.

16. (canceled)

17. The system of claim 4, wherein the Raman source includes a radiation source, a sample and optical elements configured to direct radiation from the radiation source to the sample and to direct the Raman scattered photons from the sample to an input of the interferometer.

18. The system of claim 17, wherein the radiation source includes a continuous wave laser source or a pulsed laser source wherein the radiation source produces or emits coherent radiation having a linewidth of less than about 20 MHz.

19. (canceled)

20. (canceled)

21. The system of claim 15, wherein the optical elements includes a notch filter, a prism or other device configured to isolate Stokes and/or anti-Stokes shifted Raman photons.

22.-27. (canceled)

28. A method, comprising:
obtaining, by performing Raman spectroscopy on a sample, scattered photons;
directing the scattered photons to an interferometer, the interferometer having a first optical path and a second optical path;
detecting, by at least one photo-detector, the scattered photons output from the first optical path and the second optical path at two or more different interferometer positions obtained by adjusting an optical path length of one of the first and second optical paths, wherein the interferometer transcribes temporal spectral fluctuations of the scattered photons to temporal intensity fluctuations; and
determining a frequency domain correlation function of a spectrum of the scattered photons based on an intensity-correlation analysis of the temporal intensity fluctuations at the different interferometer positions.

29. The method of claim 28, wherein the determining the spectral correlation function includes:
generating a power spectrum based on the detected scattered photons, the power spectrum indicating the temporal spectral fluctuations of the scattered photons detected by the at least one photo-detector; and
obtaining, based on correlation of the power spectrum, temporal information of the temporal spectral fluctuations at the different interferometer positions.

30. The method according to claim 28, wherein the detecting, by at least one photo-detector, the scattered photons output from the first optical path and the second optical path further comprises:
receiving the scattered photons by a first photo-detector among the at least one photo-detector output from the first optical path and by a second photo-detector among the at least one photo-detector output from the second optical path, or
receiving the scattered photons by a plurality of first photo-detectors among the at least one photo-detector output from the first optical path and by a plurality of second photo-detectors among the at least one photo-detector output from the second optical path.

31. (canceled)

32. The method according to claim 28, further comprising:
measuring a spatially-resolved spectral correlation function to obtain temporal dynamics of the temporal spectral fluctuations where the spatial resolution is obtained in either an image plane or Fourier (conjugate) plane of a sample plane of an imaging element or lens collecting Raman scattered photons.

33. The method according to claim 28, further comprising:
measuring a spatially-resolved spectral correlation function; and
obtaining an image or equivalent by reconstruction based on spectral correlation between two or more spectrally fluctuating sites of the sample as contrast mechanism.

34.-36. (canceled)

37. The method according to claim 28, wherein the detecting, by the at least one photo-detector, the scattered photons output from the first optical path and the second optical path further comprises:
adjusting a length of the first optical path to a first distance;
detecting, by the at least one photo-detector, at the first distance, the scattered photons output from the first optical path and the second optical path for a data acquisition time period;
adjusting the length of the first optical path to a second distance; and
detecting, by the at least one second photo-detector, at the second distance, the scattered photons output from the first optical path and the second optical path for the data acquisition time period.

38. The method according to claim 37, wherein the first distance and the second distance are set based on Raman bands of the sample or wherein the first distance and the second distance are periodically changed.

39. (canceled)

40. The method according to claim 28, wherein the detecting, by the at least one photo-detector, the scattered photons output from the first optical path and the second optical path further comprises:
sweeping a length of the first optical path over an incremental distance; and
detecting, by the at least one photo-detector, the scattered photons output from the first optical path and the second optical path for one or more integration times.

41. The method according to claim 28, further comprising:
determining a time of arrival for each scattered photon among the detected scattered photons at the respective photo-detector among the at least one photo-detector.

42.-50. (canceled)

51. The method according to claim 28, the method further comprising;
selecting, using one or more optical filter elements, between a plurality of Raman bands,
wherein the one or more optical filter elements are disposed between the sample and the at least one detector.

52.-56. (canceled)

57. The method according to claim 28, further comprising:
correlating two or more vibrational modes corresponding to different sites of the sample; and
obtaining or determining correlated spectral fluctuations between different domains within the sample, wherein correlated spectral fluctuations indicates correlated motion or a correlation in a parameter leading to spectral changes between different sites of the sample.

58. (canceled)

59. (canceled)

60. A method, comprising:
obtaining, by performing Raman spectroscopy on a sample using laser pulses, scattered photons;
determining a synchronization signal based on the laser pulses;
determining, based on the synchronization signal and a time-gate associated with the synchronization signal, first photons that are instantaneous Raman-scattered photons; and
generating, based on the first photons, a Raman spectral correlation function for the sample.

61.-68. (canceled)
